(19) United States
(12) Patent Application Publication
(10) Pub. No.: US 2005/0041671 A1
(43) Pub. Date: Feb. 24, 2005

(54) Network system and an interworking apparatus

(76) Inventors: Naoya Ikeda, Yokohama (JP); Shuji Ono, Yokohama (JP); Shinsuke Suzuki, Tama (JP); Mika Mizutani, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/898,352

(22) Filed: Jul. 26, 2004

(30) Foreign Application Priority Data
Jul. 28, 2003 (JP) 2003-202158
Aug. 12, 2003 (JP) 2003-207249

(51) Int. Cl. H04L 12/56

(52) U.S. Cl. 370/395.52

(57) ABSTRACT

A first internetwork apparatus connected to a network retains a plurality of IPv6 address prefixes and gives notice of an arbitrary IPv6 address prefix to a second internetwork apparatus in response to a request from the second internetwork apparatus. A second internetwork apparatus requests an IPv6 address prefix from the first internetwork apparatus, and generates a second prefix required to create an IPv6 address in a user apparatus, on the basis of one or more IPv6 address prefixes given as notice by the first internetwork apparatus. The second internetwork apparatus gives notice of the generated second prefix to the user apparatus.

### INCORPORATION BY REFERENCE

This application claims priority from Japanese applications JP2003-202158 filed on Jul. 28, 2003 and JP2003-207249 filed on Aug. 12, 2003, the contents of which are hereby incorporated by reference into this application.

### BACKGROUND OF THE INVENTION

The present invention relates to a network system capable of distributing one or more IPv6 address prefixes to user terminals, and an internetworking apparatus included in the network system to notify user terminals of one or IPv6 address prefixes.

Networks using the TCP/IP (Transmission Control Protocol/Internet Protocol) represented by Internet have spread by leaps and bounds since 1990's. In keeping therewith, techniques for easily connecting personal computers (hereafter referred to as PC) to an IP network, i.e., techniques concerning “plug and play” have been considered. An Internet Protocol mainly used in the Internet at the present time is IP Version 4, and called IPv4 as well. As a plug and play technique in the IPv4, a technique using the DHCP (Dynamic Host Configuration Protocol) is well known. In the IPv4, however, an address space has only the thirty-second power of 2 addresses, i.e., only four billion address. Therefore, there is a fear that IP addresses might be exhausted. Accordingly, future spread of the IP Version 6 (hereafter referred to as IPv6) having a very great address space, which can accommodate the one hundred twenty-eighth power of 2 addresses, is anticipated.

As the plug and play technique in the IPv6, the RA (Router Advertisement) protocol to be used by a router to distribute IPv6 addresses to terminals is used besides the DHCP. Even if a DHCP server is not especially installed, therefore, it has become unnecessary to set an IP address at a terminal.

On the other hand, in the spread of the IPv6 it is also anticipated that not only PCs but also apparatuses other than PCs, such as domestic electrification products and information home appliances, are connected to the IP network. In this case, there is a possibility that a large number of IP network devices will be present in a home. Thus, a large number of IP addresses are distributed from a service provider to the home.

A scheme in which IP addresses are distributed from a service provider to routers in customer premises as blocks is called Prefix Delegation scheme (hereafter referred to as PD scheme), and IETF (Internet Engineering Task Force), which is an Internet standardization work association, is promoting the standardization work. As regards the PD scheme, draft documents (Internet-Drafts) entitled “Requirements for IPv6 prefix delegation (draft-ietf-ipv6-prefix-delegation-requirement-02.txt)” (on Jul. 31, 2003) and “IPv6 Prefix Options for DHCPv6 (draft-ietf-dhc-dhcpv6-opt-prefix-delegation-04.txt)” (on Jul. 31, 2003) are opened to the public on a home page (http://www.ietf.org/internet-drafts/) of the IETF.

### SUMMARY OF THE INVENTION

Specifically as means for distributing addresses in the PD scheme, the server distributes 48 high-order bit portions respectively of IP addresses to routers by using the DHCP. (This is called DHCP-PD). On the basis of the IP address group, the router develops the network address into 64 bits, and distributes IP addresses to respective user terminals connected to the router. For achieving upward compatibility between the router and the user terminal, the RA protocol is used in many cases.

Hereafter, a mechanism for distributing IPv6 addresses and prefixes in the PD scheme will be described briefly with reference to FIG. 1.

As for a bit arrangement of an address in the IPv6, 64 high-order bits are defined as network address, and 64 low-order bits are defined as host address representing a terminal. In the network address, a high-order 48-bit group is an IP address part given to a subscriber, i.e., a home or enterprise connected to the Internet by an Internet connection service providing corporation (hereafter referred to as ISP), and it is called prefix. A server providing a prefix is called Prefix Delegation server (PD server). A router on the ISP side used for IP connection to the subscriber is called provider edge router, and hereafter referred to as PE router. On the other hand, a router that is an Internet connection portion in a home or an enterprise is called customer edge premise router, and hereafter referred to as CPE router.

In FIG. 1, an application server 102 provided to provide service by the ISP (Internet Service Provider) and a PE router 103 described above are connected to the Internet 101. A CPE router 104 is connected to the PE router 103, and a PC 105, which is a user terminal used by the user, is connected to the CPE router 104. In the network configuration shown in FIG. 1, the above-described PD server is incorporated in the PE router 103 as one function. Therefore, the PE router 103 shown in FIG. 1 not only functions as the router on the ISP side, but also functions as the PD server.

The PE router 103 gives notice of a 48-bit prefix to the CPE router 104 ((1)).

The CPE router 104 generates and manages 16-bit address information following the prefix (48-bit address) supplied from the PE router 103. The CPE router 104 adds 16-bit information created by the CPE router 104 itself to the prefix so as to place the 16-bit information in order below the prefix, and generates an address (hereafter referred to as new prefix) corresponding to the 64-bit network address. The CPE router 104 notifies the PC 105 connected to itself of the new prefix by using the RA protocol ((2)).

The PC 105 combines the new prefix with a 64-bit address called interface identifier as its own identifier, and generates a unique 128-bit IPv6 address (global address) ((3)).

Thus, by providing the CPE router 104 with a prefix by using the mechanism of DHCP-PD, it becomes unnecessary to manually set IP address groups to be distributed to user terminals such as the PC 105.

When the CPE router 104 notifies the user terminal such as the PC 105 of the new prefix, the RA protocol is used as standard specifications of the IPv6 protocol. As a result, the user of the user terminal need not set an IP address himself or herself on the user terminal.

On the user terminal such as the PC 105, an EUI-64 identifier (a global identifier defined by IEEE) may be created as an interface identifier of itself on the basis of a 48-bit MAC identifier (MAC address) prescribed in IEEE 802 and used as the interface identifier, or the interface identifier may be determined on the basis of generation of a random number.

According to the scheme heretofore described, each user terminal automatically generates an IPv6 address. Therefore, the address setting work conducted by the user of the user terminal can be lightened.

Basically, however, each user terminal is provided with only one IP address by the PD scheme. It is not supposed that one user terminal is provided with a plurality of IP addresses. Providing each user terminal with only one IP address is premised on the assumption that each user using a user terminal enjoys one service provided by one ISP. For example, a form in which the user utilizes different services provided by different ISPs respectively for a plurality of IP addresses provided for the user terminal is not considered not only in the IPv4 having a small address space but also in the IPv6 having a very large address space.

Considering that sophisticated services utilizing the IP will more and more increase from now on, users demands for the utilization form as described above are anticipated to gradually rise. For example, as a utilization form of the VoIP function (voice communication using IP packets) in a user terminal, it is conceivable that the user uses a certain IP address for business and uses another IP address for private use. In such a case, the convenience of the user terminal is also further improved.

On the other hand, a technique concerning a network file server provided with a plurality of IP addresses by arranging different OS spaces in an external storage apparatus and providing respective OSs with protocol stacks is disclosed in U.S. Pat. No. 5,634,111 (JP-A-5-265914). In the technique disclosed in this paper, however, each OS is provided with two or more Internet protocol stacks in order to support two or more operating systems (OSs) simultaneously in a network file server (multi-operating system terminal). And each IP stack is provided with an IP address, and each OS uses storage apparatuses properly. In this way, the technique disclosed in the above-described paper does not switch the use environment of the application and utilize it in the environment of one OS and one protocol stack.

Therefore, an object of the present invention is to provide a network system capable of providing a user terminal with a plurality of different IP addresses and providing a user with different Internet services, and an Internet apparatus included in the network system.

Another object of the present invention is to provide a method of using a plurality of IPv6 addresses corresponding to use environments of a plurality of applications, and an apparatus based on the method.

In accordance with the present invention, each of one or more first internetwork apparatuses is configured to previously retain a plurality of IPv6 address prefixes and give notice of an arbitrary IPv6 address prefix included in the retained IPv6 address prefixes to a second internetwork apparatus in response to a request from the second internetwork apparatus.

A second internetwork apparatus requests an IPv6 address prefix from each of the first internetwork apparatuses, and generates a second prefix required to create an IPv6 address in the user apparatus, on the basis of each of the one or more arbitrary IPv6 address prefixes given as notice by the one or more first internetwork apparatuses. And the second internetwork apparatus is configured to give notice of the one or more generated second prefixes to the user apparatus.

Upon receiving the second prefixes, the user apparatus creates a plurality of IPv6 addresses, and manages the created addresses so as to associate them with the application use environment in the user apparatus.

According to the present invention, it is possible to provide a mechanism capable of distributing prefixes from a plurality of ISPs to one user terminal respectively via PE routers. As a result, the user terminal can receive a plurality of prefixes via a CPE router, and create and manage a plurality of IPv6 addresses.

Other objects, features and advantages of the invention will become apparent from the following description of the embodiments of the invention taken in conjunction with the accompanying drawings.

### BRIEF DESCRIPTION OF THE DRAWINGS

FIG. 1 shows a configuration of a network system that distributes prefixes by using the PD scheme;

FIG. 2 shows a configuration of a network system in an embodiment;

FIG. 3 shows an example of a prefix pool table 300;

FIG. 4 is a flowchart of prefix information notice processing 400;

FIG. 5 shows an example of an access line management table 500;

FIG. 6 is a flowchart of prefix information acquisition processing 600;

FIG. 7 shows an example of a DNS relay management table 700;

FIG. 8 is a flowchart of DNS relay processing 800;

FIG. 9 is a flowchart of transmission source address selection processing 900;

FIG. 10 shows a software configuration of a PC 208;

FIG. 11 shows a configuration example of a prefix management table 1100;

FIG. 12 shows a configuration example of an I/F address management table 1200;

FIG. 13 shows a configuration example of an ISP information management table;

FIG. 14 is a flowchart of address generation processing 1400;

FIG. 15 is a flowchart of transmission source address selection processing 1500;

FIG. 16 shows a configuration example of an access line management table 1600;

FIG. 17 shows a hardware configuration of a PC208;

FIG. 18 shows a configuration example of an I/F address management table 1800;

FIG. 19 shows a configuration example of an address generation management table 1900;

FIG. 20 is a flowchart of address generation processing 2000;

FIG. 21 is a flowchart of initial processing 2100 at the time of application start;

FIG. 22 is a flowchart of application end processing 2200;

FIG. 23 shows a configuration example of a destination address management table 2300;

FIG. 24 is a flowchart of SIP client processing 2400;

FIG. 25 shows a configuration example of an IP packet network system for portable telephone;

FIG. 26 shows a hardware configuration of a portable telephone 2560;

FIG. 27 shows a configuration example of a terminal management table 2700;

FIG. 28 shows a configuration example of an address generation management table;

FIG. 29 shows a configuration of a PE router A 205;

FIG. 30 shows a configuration of a management unit 2910 in a PE router A 205; and

FIG. 31 shows a configuration of a management unit 3100 in a CPE router 207.

### DETAILED DESCRIPTION OF THE EMBODIMENTS

Hereafter, an embodiment of the present invention will be described in detail with reference to the drawings. However, the present invention is not restricted to contents of the embodiment hereafter described.

In a network system in the embodiment, a plurality of prefixes are distributed to each user terminal so as to make it possible for the user to utilize different services respectively by using a plurality of IP addresses.

Herein, the “user terminal” refers to an apparatus, such as a personal computer (PC), a personal digital assistant (PDA), a mobile telephone or a server, that is used by a user and that can conduct communication by using the IP.

For simplifying the scheme, it is now supposed that a plurality of ISPs (or enterprise networks) distribute respective prefixes from respective PE routers to the user terminal via the CPE router by using a plurality of lines (a plurality of channels in the same physical line are regarded as different lines).

In such a case, the PE router, the CPE router and the user terminal have the following functions as hereafter described in detail.

(1) The CPE router conducts route management on the PE router in order for the user terminal to select connection service.

(2) In connection with (1), the CPE router selectively relays a DNS request packet to a plurality of servers in order to make it possible for the user terminal to select a DNS server according to service.

(3) The CPE router requests respective prefixes from one or more ISPs that could be known by contracts or the like beforehand.

(4) The PE router supplies information required for the CPE router to implement (1) and (2) to the CPE router as additional information of the prefix.

(5) The user terminal selects a plurality of new prefixes supplied from the CPE router by using the RA protocol from information concerning usable ISPs, and generates and manages one or more usable IP addresses based on one or more new prefixes.

(6) The user terminal selects its own IP address suitable for a destination address to be accessed by an application (or the user), from the one or more IP addresses described in (5), and conducts communication by using the selected IP address as a source address.

Since the PE router, the CPE router and the user terminal have the functions described heretofore, it becomes possible for the user to selectively utilize services of a plurality of ISPs by using a plurality of IP addresses provided for the user terminal.

A configuration of the network system and operation of the PE router, the CPE router and the user terminal in the embodiment will now be described concretely with reference to the drawings.

FIG. 2 shows a configuration of a network system in the embodiment.

With reference to FIG. 2, an application server A 202 provided by the ISP1 to provide Internet service is connected to Internet 201. Furthermore, at least one base (hereafter referred to as office) 203 included in an intra-enterprise network operated by one or more enterprises is connected to the Internet 201. The enterprise connects offices 203 together or connects the office 203 to a user terminal used by an employee (user) of the enterprise via the Internet 201 by utilizing a VPN (Virtual Private Network) service provided by, for example, an ISP2, which is different from the ISP1, and thereby constructs an intra-enterprise network. In FIG. 2, an application server B 204 for providing the office 203 with service in the intra-enterprise network is connected to the office 203.

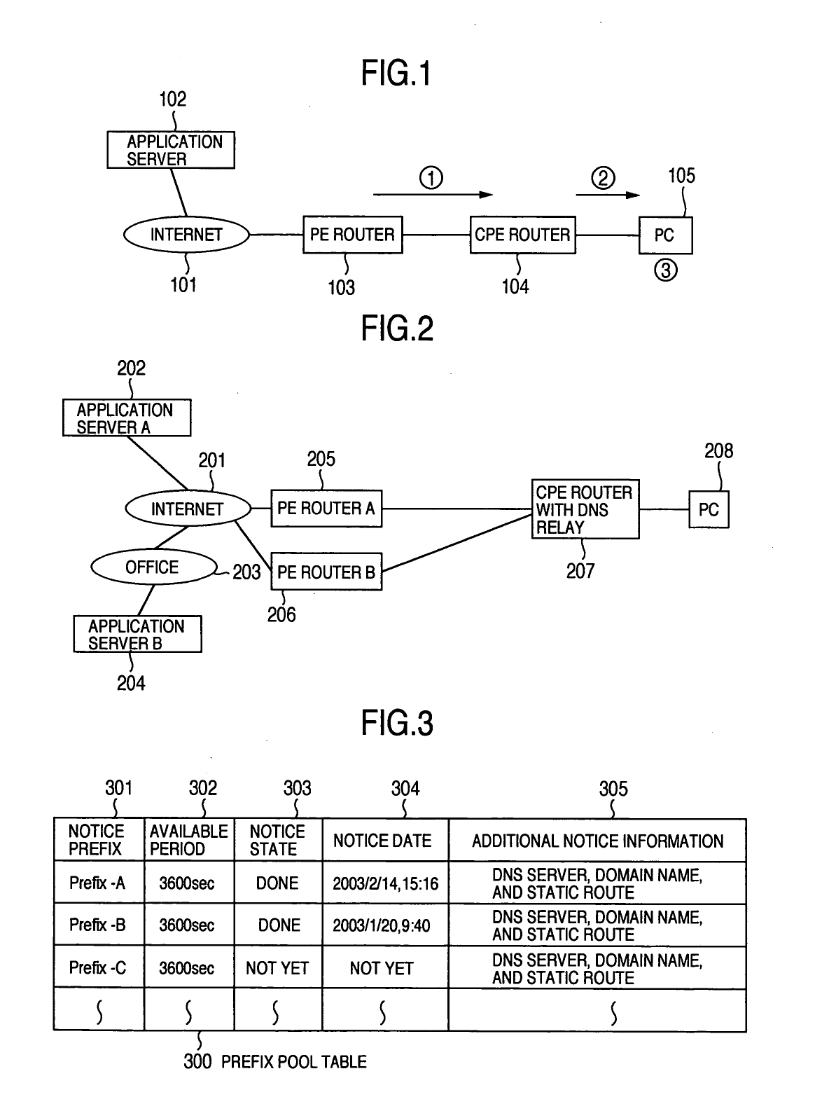

In addition, a PE router A 205 and a PE router B 206 are connected to the Internet 201. By the way, in FIG. 2 as well, a PD server for providing a prefix is incorporated in each PE router as one function in the same way as the network configuration shown in FIG. 1. Therefore, the PE router A 205 and the PE router 206 shown in FIG. 2 also not only function as routers on the ISP side, but also distribute prefixes as PD servers. In the ensuing description as well, it is supposed that the PE router incorporates the function of the PD server.

A CPE router 207 is connected to the PE router 205 and the PE router 206. A PC 208, which is a user terminal used by the user, is connected to the CPE router 207. The CPE router 207 has a DNS relay function described in detail later. Although the user terminal is supposed to be the PC 208, the user terminal is not restricted to a PC, but the user terminal may be a mobile telephone or a personal digital assistant (PDA) so long as network communication can be conducted by using the apparatus.

In this network system, the two PE router A 205 and the PE router B 206 give notice of prefixes having different IP addresses to the CPE router 207. For example, the PE router A 205 distributes a prefix (hereafter referred to as prefix A) of an IP address (hereafter referred to as IP address A) prepared by the ISP1 to provide the user with Internet service, and the PE router B 206 distributes a prefix (hereafter referred to as prefix B) of an IP address (hereafter referred to as IP address B) prepared by the ISP2 to provide the user with VPN service.

By the way, a network coupling the PE router A 205 to the CPE router 207 and a network coupling the PE router B 206 to the CPE router 207 are respectively called access lines, and shown in FIG. 2 as if they are physically separated. However, those access lines may be physically one line, or may be multiplexed in the layer 1 or layer 2. This is typically implemented by, for example, different PPP (Point to Point Protocol) links on an ADSL line.

A concrete configuration and operation of the PE router and the CPE router in the network system shown in FIG. 2 will now be described.

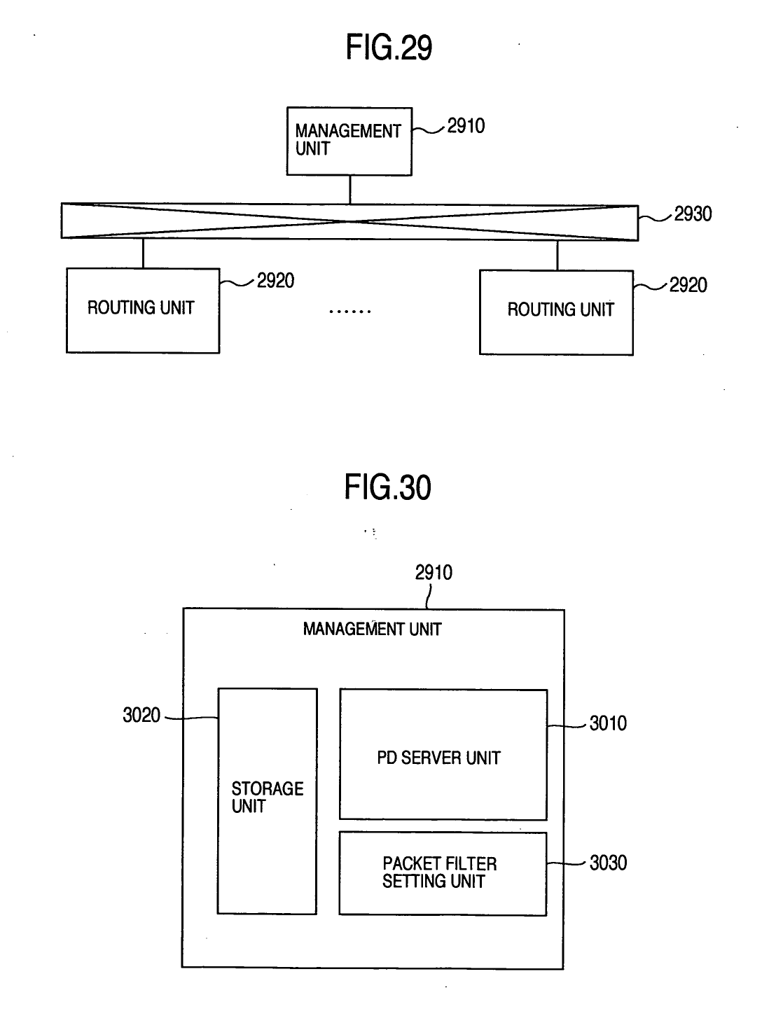

FIG. 29 shows a configuration of the PE router A 205.

Since the PE router A 205 and the PE router B 206 have basically the same configuration, only the PE router A 205 is shown in FIG. 29. The PE router A 205 includes a management unit 2910 and a plurality of routing units 2920. Respective units are connected via a crossbar switch 2930. For example, respective units may be connected via a packet bus instead of the crossbar switch 2930.

The management unit 2910 includes a processor, which executes a program for collecting routing information, creating a routing table and distributing the routing table to respective routing units, a memory for storing the routing table and the program, a buffer memory for storing packets to be transmitted and received packets, a buffer memory controller for controlling packet DMA transfer and packet bus between it and a buffer memory in a routing unit, a hard disk, and an internal bus for connecting them.

The routing unit 2920 includes a port control unit having a plurality of ports for connection to other routers and the CPE router 207, a processor for executing programs to transfer received packets between ports, between routing units, or between a routing unit and the management unit on the basis of the routing table created by the management unit, a memory for storing these programs and the routing table, a buffer memory for storing packets to be transmitted and received packets, a buffer memory controller, and an internal bus for connecting them.

FIG. 30 shows a configuration of the management unit 2910 in the PE router A 205.

In FIG. 30, the management unit 2910 includes a PD server unit 3010, a storage unit 3020, and a packet filter setting unit 3030. The PD server unit 3010 gives notice of a prefix of an IP address to the CPE router 207 as described above. The storage unit 3020 stores a prefix pool table 300 described later and other information. The packet filter setting unit 3030 permits relaying of a packet including the noticed prefix, and sets a packet filter for discarding other packets. Detailed operations of the respective units will be described later.

The CPE router 207 is a router device corresponding to the IPv6. A basic configuration of the CPE router 207 is the same as that of the PE router A 205 and the PE router B 206 shown in FIG. 29. Or the CPE router 207 may include only a management unit included in the PE router, and a port control unit having a plurality of ports connected to a PE router or an end terminal via a packet bus in the management unit may be connected to the CPE router 207.

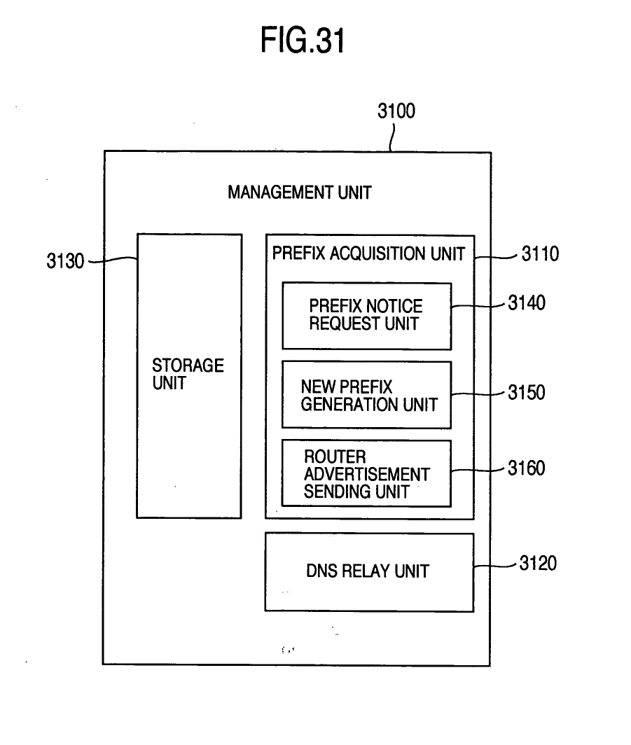

FIG. 31 shows a configuration of a management unit 3100 in the CPE router 207.

In FIG. 31, the management unit 3100 includes a prefix acquisition unit 3110, a DNS relay unit 3120, and a storage unit 3130. The prefix acquisition unit 3110 includes a prefix notice request unit 3140, a new prefix generation unit 3150 and a router advertisement sending unit 3160. Detailed operations of respective components will be described later.

Operation of the PE router 205 and the PE router 206 will now be described. Since the PE router 205 and the PE router 206 have the same configuration, only operation of the PE router 205 will now be described.

As described above, the PE router 205 has not only a configuration for serving as an ordinary router, but also a configuration for giving notice of a prefix to the CPE router 207 as the PD server. FIG. 3 shows an example of a prefix pool table 300 included in the PE router A 205 to implement the PD server function. The prefix pool table 300 is used to record prefix information to be given to the CPE router 207 as notice and manage its notice situation. Contents of the prefix pool table 300 are stored in the storage unit 3020 included in the management unit 2910 in the PE router A 205.

In FIG. 3, the prefix pool table 300 includes a notice prefix field 301 for registering the prefix to be given to the CPE router 207 as notice, an available period field 302 indicating a utilization permission period of a notice prefix since the notice of the prefix is sent to the CPE router 207, a notice state field 303 indicating the notice situation of each prefix to the CPE router 207, a notice date field 304 indicating the date on which the notice of the prefix has been given to the CPE router, and an additional notice information field 305 storing information to be given to the CPE router 207 as notice together with each prefix. A value of the prefix and a prefix length, which indicates the validity range of the prefix, are also registered together in the notice prefix field 301. Various kinds of information including, for example, a domain name that the ISP1, ISP2 or an enterprise included in the intra-enterprise network has, and address information of a DNS server which manages domain information concerning the domain name are registered in the additional notice information field 305.

The prefix pool table 300 can have a plurality of entries each having the above-described fields one by one. As a result, the PE router A 205 can manage a plurality of sets of prefix information to be given to the CPE router 207 as notice. By the way, contents of the notice prefix field 301, the available period field 302 and the additional notice information field 305 are previously set in each entry of the prefix pool table 300 automatically at the time of apparatus start or in response to an input given by a manager as occasion demands.

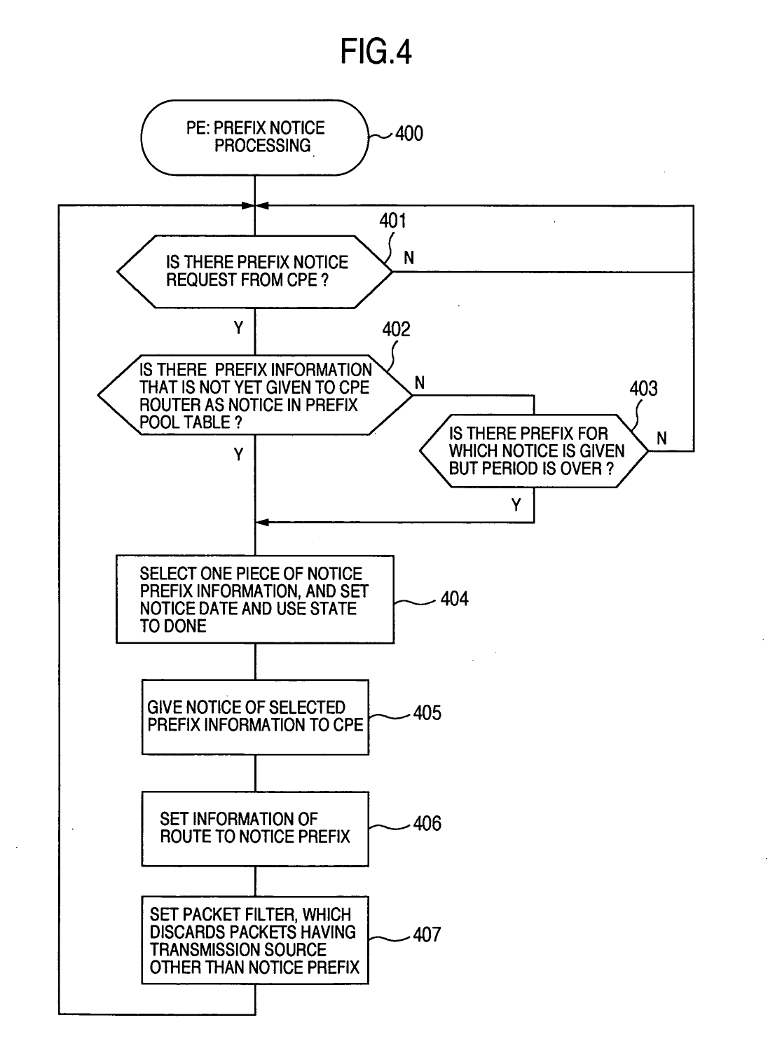

FIG. 4 is a flowchart showing processing conducted when the PE router A 205 gives notice of prefix information to the CPE router 207. This flowchart shows an example of processing (prefix information notice processing) 400 conducted by the PD server unit 3010 included in the management unit 2910 in the PE router A 205 to give notice of prefix information by using the prefix spool table 300 in response to a request from the CPE router 207.

In the processing 400, the PD server unit 3010 first waits for reception of a prefix notice request from the CPE router 207 (Step 401). Upon receiving the prefix notice request from the CPE router 207, the PD server unit 3010 checks the notice state field 303 of each entry in the prefix pool table 300 stored in the storage unit 3020, and searches for contents “not yet”, i.e., searches for a prefix that is not yet given to the CPE router 207 as notice (Step 402).

If a prefix that is not yet given to the CPE router 207 as notice is not present, then the PD server unit 3010 determines whether there is a prefix for which the utilization available period after the notice of the prefix information is over, on the basis of the current time in an internal clock in the PE router A 205, and information registered in the available period field 302 and the notice date field 303 of each entry in the prefix spool table 300 (Step 403). If there is not a prefix for which the utilization available period is over, then the PD server unit 3010 suspends the prefix notice processing, and returns to Step 401 without giving notice of prefix information to the CPE router 207.

On the other hand, if it is found at Step 402 or Step 403 that registered prefixes for which notice is not yet given and the utilization permission period is over is present in the prefix pool table 300, then the PD server unit 3010 selects arbitrary one (for example, a prefix found first) from among them, sets the current date in the notice date field 304 of an entry having the prefix registered therein, and sets the content of the notice state field to “done” (Step 404). And the PD server unit 3010 gives notice of the selected prefix and information stored in the additional notice information field 305 together to the CPE router 207 as prefix information (Step 405).

Thereafter, the PD server unit 3010 sets static route information to the notice prefix, in the routing table (Step 406). Furthermore, the PD server unit 3010 permits relay of only a packet having an IPv6 address that contains the notice prefix in 48 high-order bits, as the transmission source address, and orders the packet filter setting unit 3030 to discard other packets. The packet filter setting unit 3030 sets a packet filter on the basis of the order (Step 407).

And the PD server unit 3010 returns to the first Step 401 of the prefix information notice processing 400, and waits for reception of a new prefix notice request from the CPE router 207.

Owing to the processing conducted by the PD server unit 3010 and described heretofore, the PE router A 205 can give notice of prefix information in response to a request from the CPE router 207, and then conduct packet relay to the CPE router 207 in accordance with route information to the notice prefix. Furthermore, by setting the packet filter on the basis of the notice prefix, the PE router A 205 can prevent access (packet transmission) from an illegal transmission source (for example, a terminal apparatus for which notice of prefix information has not been given).

Subsequently, operation of the CPE router 207 will be described.

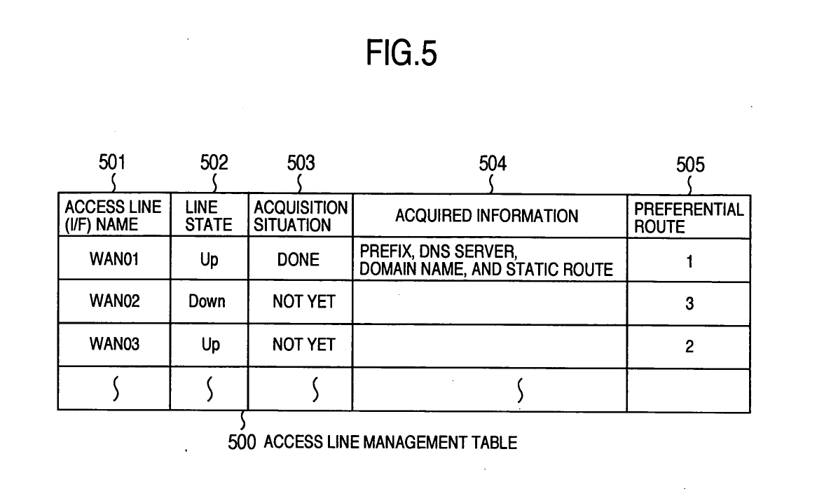

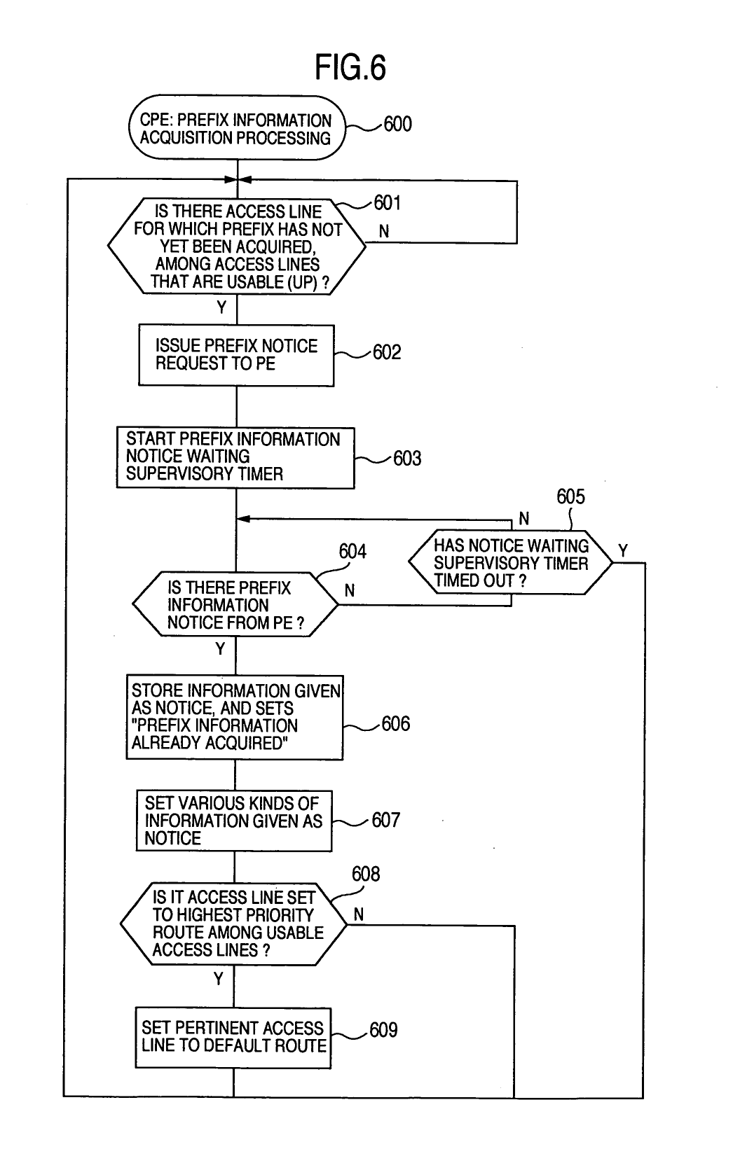

Processing (prefix information acquisition processing) of receiving notice of prefix information from the PE router A 205 and the PE router B 206 conducted by the management unit 3100 in the CPE router 207 will now be described with reference to FIGS. 5 and 6.

FIG. 5 shows an example of an access line management table 500 included in the CPE router 207 to register and manage the state of the access line to the Internet 201 and the acquisition situation of prefix information of every access line. Contents of the access line management table 500 are stored in the storage unit 3130 in the management unit 3100.

In FIG. 5, the access line management table 500 includes an access line (I/F) name field 501 including identification information of an access line (interface: I/F) that can be used by the CPE router 207, a line state field 502 indicating the state (Up/Down) of each access line, an acquisition situation field 503 indicating an acquisition situation of prefix information from the PE router A 205 and the PE router B 206, an acquired information field 504 for registering prefix information given as notice by each PE router therein, and a preferential route field 505 storing the priority (order) of each access line to be used when the CPE router 207 transmits packets, i.e., storing a value of priority (for example, an integer in the range of 1 to n, where 1 indicates the highest priority and n indicates the lowest priority), which indicates an access line to be used preferentially in packet transmission. Various kinds of information including the prefix given as notice, additional notice information given as notice together with the prefix, such as a domain name that the ISP1, ISP2 or an enterprise included in the intra-enterprise network has, and address information of a DNS server which manages domain information concerning the domain name are registered in the acquired information field 504.

The access line management table 500 can have a plurality of entries each having the above-described fields one by one. By using the access line management table 500, the CPE router 207 can utilize a plurality of access lines at the same time. By the way, contents of the access line (I/F) name field 501 and the preferential route field 505 are previously set in each entry of the access line management table 500 automatically at the time of apparatus start or in response to an input given by a manager as occasion demands.

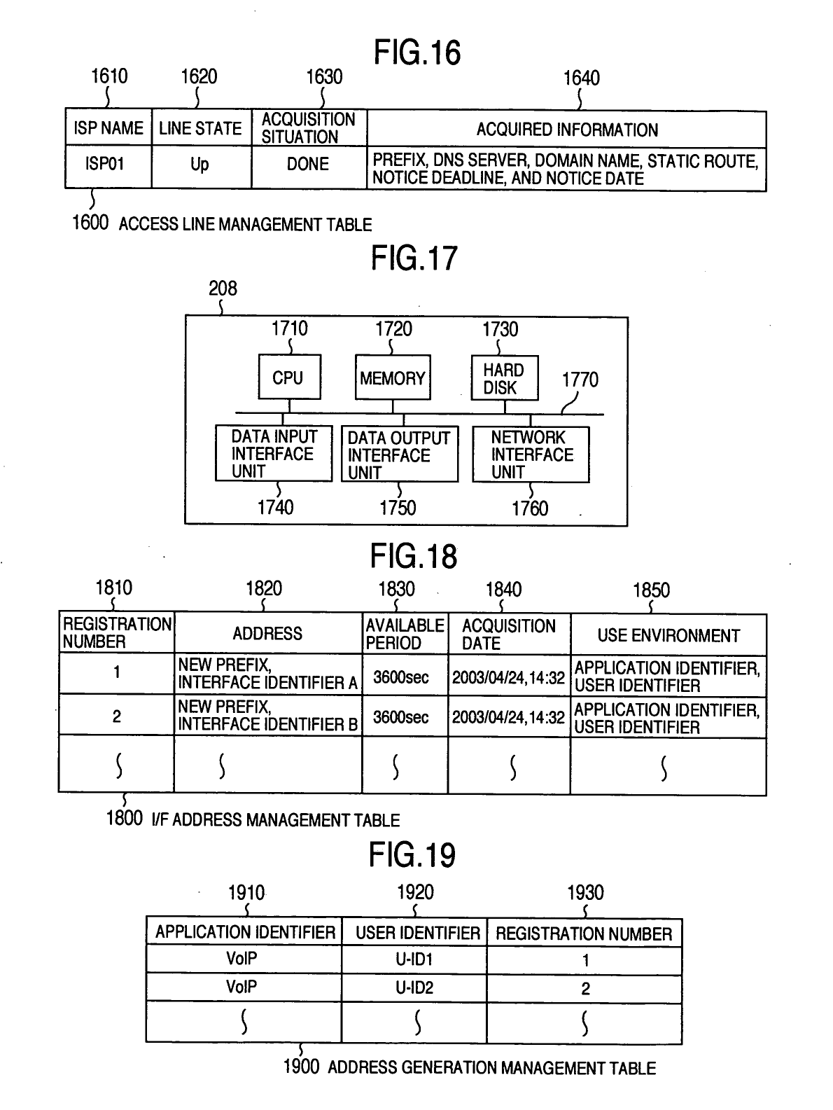

FIG. 16 shows another example of the access line management table.

An access line management table 1600 shown in FIG. 16 differs from the access line management table 500 shown in FIG. 5 in that an ISP name field 1610 containing a name (identification information) of an ISP is provided instead of the access line (I/F) name field. Besides, the access line management table 1600 includes a line state field 1620, an acquisition situation field 1630, and an acquired information field 1640. The line state field 1620, the acquisition situation field 1630, and the acquired information field 1640 are the same as the line state field 502, the acquisition situation field 503, and the acquired information field 504 shown in FIG. 5. A name or identification information of an ISP under a contract is set in the ISP name field 1610 of each entry by a manager or automatically when the apparatus is started. Furthermore, “Up” in the line state field 1620 of each entry indicates the state in which the CPE router 207 is coupled to the ISP, and indicates a state in which the CPE router 207 can obtain the prefix information. For example, if a link of the PPPoE (Point to Point Protocol over Ethernet) is set up between the CPE router 207 and the ISP, then contents of the line state field 1620 are changed from “Down” to “Up.”

FIG. 6 is a flowchart showing processing conducted when the CPE router 207 acquires prefix information from the PE router A 205 or the PE router B 206. This flowchart shows an example of prefix information acquisition processing 600 conducted by the prefix acquisition unit 3110 included in the management unit 3100 in the CPE router 207.

After, for example, the CPE router 207 has finished authentication processing between the CPE router 207 and the PE router A 205 or the PE router B 206 and the link (PPPoE) has been set up, the prefix information acquisition processing is conducted as the next processing.

In the prefix information acquisition processing 600, the prefix notice request unit 3140 in the prefix acquisition unit 3110 refers to the line state field 502 and the acquisition situation field 503 of each entry in the access line management table 500 stored in the storage unit 3130. The prefix notice request unit 3140 determines whether there is an access line for which the contents of the line state field 502 are “Up” indicating that the line can be used and the contents of the acquisition situation field 503 are “Not yet,” i.e., whether there is an access line for which prefix information has not yet been acquired (Step 601). If as a result there is no corresponding access line, then Step 601 is repeated until a corresponding access line is found.

On the other hand, if there is a corresponding access line, then the prefix notice request unit 3140 issues a prefix notice request to the access line (Step 602). It is now supposed that the prefix notice request unit 3140 issues a prefix notice request to an access line connected to the PE router A 205. If the prefix notice request unit 3140 issues a prefix notice request, then the prefix acquisition unit 3110 starts an internal supervisory timer (not illustrated) (Step 603). The prefix acquisition unit 3110 waits for reception of notice of prefix information from the PE router A 205 over a fixed period lasting until the supervisory timer times out (Step 604 and Step 605). If the supervisory timer has timed out before notice of the prefix information is given by the PE router A 205, then the prefix acquisition unit 3110 suspends the prefix information acquisition processing and returns to Step 601.

On the other hand, if notice of the prefix information is received from the PE router A 205 before the supervisory timer times out, then the prefix acquisition unit 3110 registers the received prefix information in the acquired information field 504 of an entry having registration of an access line for which prefix information has been received, in the access line management table 500, and sets information indicating that information has been acquired (“done”) in the acquisition situation field 503 of the entry (Step 606).

And the prefix acquisition unit 3110 sets an IPv6 address for a line I/F to be connected to the PC 208 on the basis of the received prefix, sets a DNS server address and a domain name in a DNS relay management table 700 in accordance with additional notice information received together with the prefix, and sets static route information in a routing table included in the prefix acquisition unit 3110. In this way, the prefix acquisition unit 3110 conducts various kinds of setting (Step 607).

The routing table in the foregoing description is a table that the router has as an indispensable function, and it is a table for dynamically or statistically managing relay destinations of received packets. Since the routing table is a technique already known to those skilled in the art, its concrete description will be omitted.

Thereafter, the prefix acquisition unit 3110 determines whether a value of priority in the preferential route field 505 corresponding to an access line for which prefix information has been received this time, included in usable access lines registered in the access line management table 500 indicates a highest priority among priority values in the preferential route field 505 of all entries in the access line management table 500 (Step 608).

Here, “usable access line” refers to an access line for which contents of the line state field 502 are “Up” and contents of the acquisition situation field 503 are “Done.”

If the value of priority in the preferential route field 505 corresponding to the access line for which prefix information has been received is judged at Step 608 to indicate a highest priority, then the prefix acquisition unit 3110 sets the access line in the routing table as a default route (a route to be used when relaying a packet having no corresponding route information in the routing table) (Step 609).

And the prefix acquisition unit 3110 returns to the first Step 601 in the prefix information acquisition processing 600.

By the way, if there are a plurality of pertinent access lines at Step 601, then the prefix notice request unit 3140 may select access lines one by one in the order of registration in the access line management table 500 and conduct subsequent processing (Step 602 and subsequent steps), or the prefix notice request unit 3140 may select access lines successively in the order of descending priority in the preferential route field 505 corresponding to the access lines.

At Step 607, the new prefix generation unit 3150 in the prefix acquisition unit 3110 adds information of 16 bits (2 bytes) generated by itself to the received prefix, and creates a 64-bit new prefix corresponding to the network address. The 16-bit information added by the new prefix generation unit 3150 becomes “0” when, for example, a plurality of subnetworks are not formed in a network placed under the CPE router 207.

The new prefix generation unit 3150 in the prefix acquisition unit 3110 sets an IPv6 address including a new prefix created for a line I/F connected to the PC 208.

Furthermore, the router advertisement sending unit 3160 in the prefix acquisition unit 3110 sends a router advertisement to the PC 208 by using the RA protocol, and gives notice of the new created prefix to the PC 208. In order to give new prefixes to all user terminals connected to itself, the router advertisement sending unit 3160 periodically transmits the router advertisement. By the way, the router advertisement sending unit 3160 may also execute the processing of giving notice of the new prefix in response to a new prefix notice request issued by the PC 208.

Upon receiving the new prefix, for example, an EUI-64 identifier is combined with the received new prefix as an interface identifier to generate a unique 128-bit IPv6 address (global address) in the PC 208, and the IPv6 address is automatically set in the PC 208.

Owing to the processing conducted by the prefix acquisition unit 3110 and described heretofore, it becomes possible for the CPE router 207 to receive notice of prefix information from a plurality of access lines, i.e., a plurality of PE routers. Furthermore, since a default route is automatically set on the basis of priority previously set in the preferential route field 505 of each entry in the access line management table, a certain amount of communication using the CPE router 207 can be secured provided that any access line can be used.

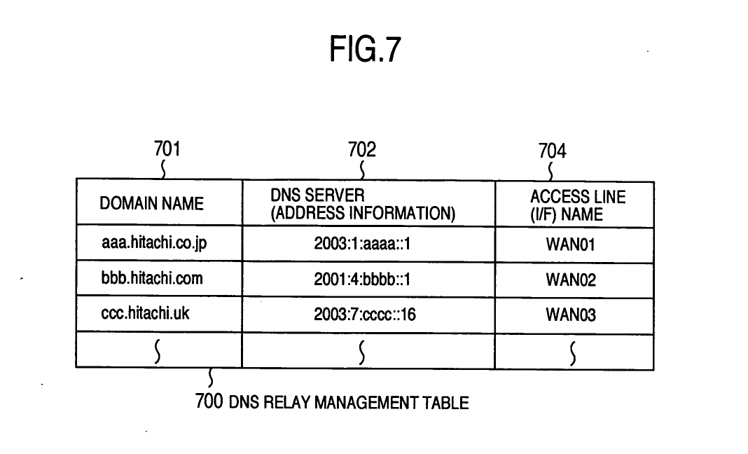

Upon receiving a DNS (Domain Name Service) query from the PC 208, the DNS relay unit 3120 included in the management unit 3100 in the CPE router 207 transfers the DNS query to a proper DNS server. This DNS relay processing will now be described with reference to FIGS. 7, 8 and 9.

FIG. 7 shows an example of a DNS relay management table 700 included in the DNS relay unit 3120 to implement the DNS relay. The DNS relay management table 700 functions to manage relations between address information of DNS servers serving as transfer destinations of respectively access lines and domain names. Contents of the DNS relay management table 700 are stored in the storage unit 3130 included in the management unit 3100 in the CPE router 207. By the way, the storage unit 3130 stores the DNS relay management table 700, the above-described access line management table 500 or 1600, and other information, as well.

In FIG. 7, the DNS relay management table 700 includes a domain name field 701 for registering a domain name included in the additional notice information given together with the prefix by each PE router, a DNS server (address information) field 702 for registering address information (IPv6 address) of the DNS server included in the additional notice information, and an access line (I/F) name field 703 including identification information of the access line for which the prefix information has been received.

The DNS relay management table 700 can have a plurality of entries each including one set of fields. Whenever notice of the prefix information is given by each PE router, the prefix acquisition unit 3110 stores contents of the prefix information in the acquired information field 504 in the access line management table 500, and stores respective kinds of information included in the prefix information in respective fields of the DNS relay management table 700.

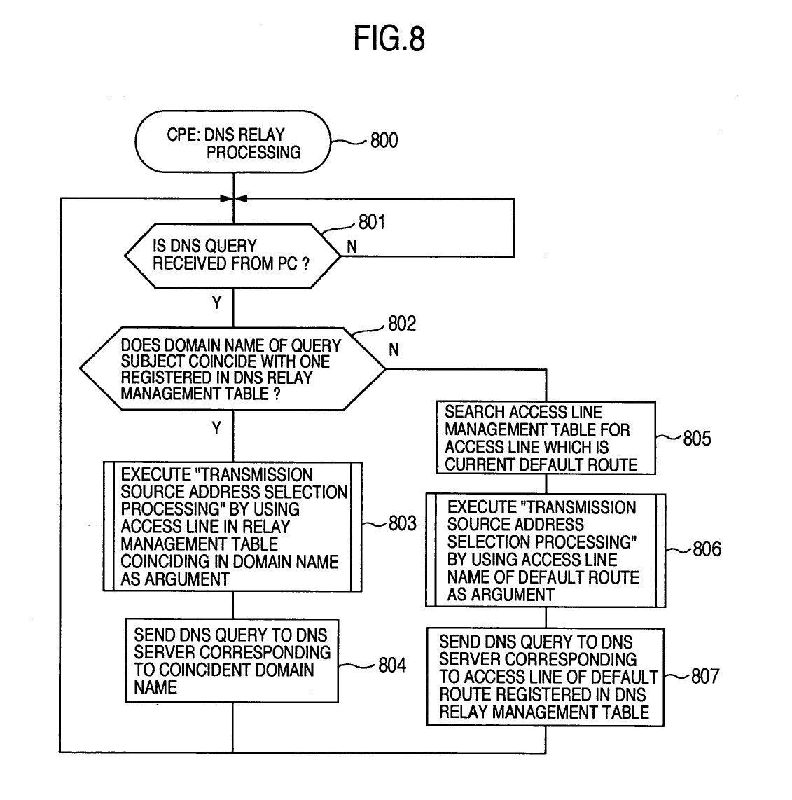

Upon receiving a DNS query from the PC 208, the DNS relay unit 3120 transfers the DNS query to a proper DNS server in accordance with information registered in the DNS relay management table 700. FIG. 8 is a flowchart showing an example of this DNS relay processing 800. By the way, as a premise for the DNS relay processing, the IP address of the CPE router 207 is previously set in the PC 208 as the address of the DNS server. As a result, the PC 208 issues a DNS query to the CPE router 207.

In the DNS relay processing 800, the DNS relay unit 3120 determines whether a DNS query has been received from the PC 208 (Step 801). Upon receiving the DNS query from the PC 208, the DNS relay unit 3120 checks whether a domain name coinciding with a domain name of the query subject has already been registered in the domain name field of each entry in the DNS relay management table 700 (Step 802). If a coinciding domain name is registered in any entry, then the DNS relay unit 3120 reads out access line identification information from the access line (I/F) name field 703 of that entry. The DNS relay unit 3120 executes transmission source address selection processing 900 described later by using the identification information as an argument, and determines a transmission source address to be used in a DNS query message (packet) to be generated (Step 803). Furthermore, the DNS relay unit 3120 reads out address information (IPv6 address) registered in the DNS server (address information) field 702 of that entry, and creates a DNS query message (packet) including that address as a destination address, including the transmission source address determined at Step 803 intact as the transmission source address, and having the same contents as the DNS query from the PC 208. And the DNS relay unit 3120 sends out the DNS query message (packet) to an access line identified by the access line identification information read out at Step 803 (Step 804).

Instead of newly creating a DNS query message (packet), the DNS relay unit 3120 may convert the destination address included in the DNS query from the PC 208 to the address information read out, convert the transmission source address to the transmission source address determined at Step 803, and transmit the DNS query. Or the DNS relay unit 3120 may newly add a header having the address information read out as the destination address and having the determined transmission source address as the transmission source address to the DNS query from the PC 208, and transmit a resultant DNS query.

On the other hand, if it is found at Step 802 that the coincident domain name is not registered in any entry, then the DNS relay unit 3120 recognizes the access line set in the routing table as the default route by the above-described prefix information acquisition processing 600, by referring to the access line management table 500. Specifically, the DNS relay unit 3120 finds entries in which contents of the line state field 502 are “Up” and contents of the acquisition situation field 503 are “Done,” selects an entry in which the priority value in the preferential route field 505 indicates the highest priority from among the entries thus found, and reads out access line identification information from the access line (I/F) name field 703 of the selected entry (Step 805). The DNS relay unit 3120 executes transmission source address selection processing 900 described later by using the access line identification information thus read out as an argument, and determines a transmission source address to be used in the DNS query message (packet) generated by the CPE router 207 (Step 806). Furthermore, the DNS relay unit 3120 extracts an entry in which access line identification information coinciding with the access line identification information read out had been registered, from the DNS relay management table 700, and reads out address information (IPv6 address) registered in the DNS server (address information) field 702 of the extracted entry in the same way as the above-described step 804. The DNS relay unit 3120 creates a DNS query message (packet) including that address as a destination address, including the transmission source address determined at Step 806 intact as the transmission source address, and having the same contents as the DNS query from the PC 208. And the DNS relay unit 3120 sends out the DNS query message (packet) to an access line recognized at Step 805 (Step 807).

Owing to the processing conducted by the DNS relay unit 3120 and described heretofore, it becomes possible for the CPE router 207 to send a DNS query to a DNS server that differs depending upon the domain name of the DNS query subject. Since the processing heretofore described is conducted by only the CPE router 207, it is not necessary to cause the PC 208, which actually issues a DNS query, to be conscious of any thing, and it is not necessary to alter the function of the PC 208 or add a new function to the PC 208.

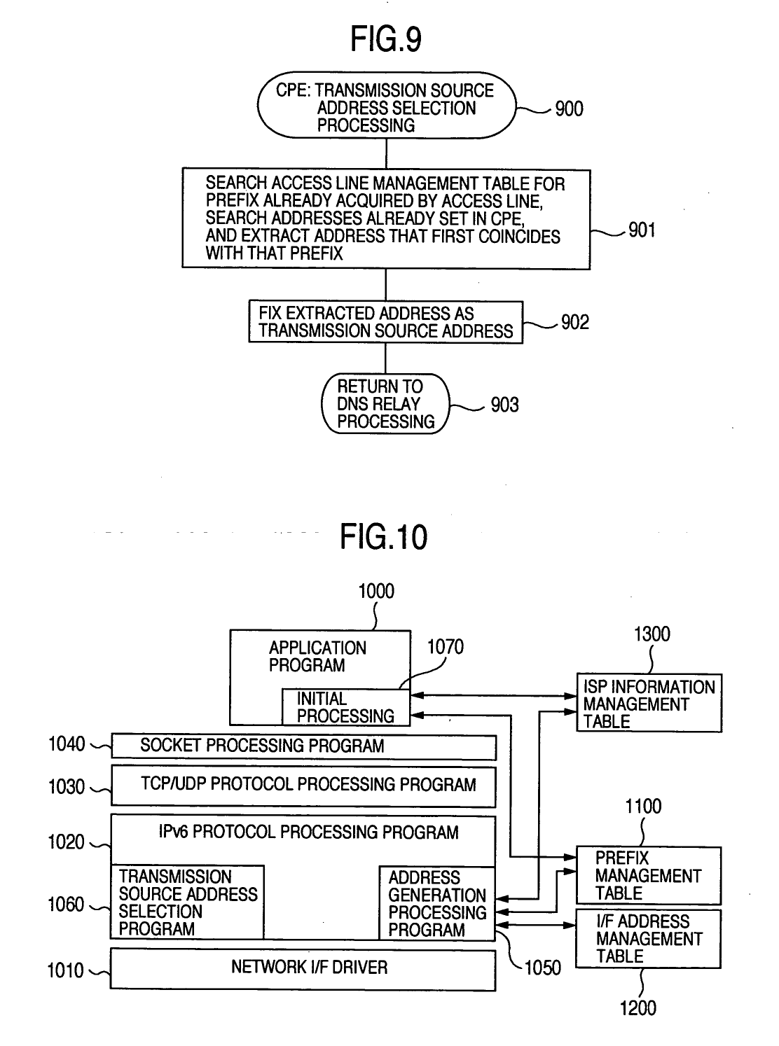

FIG. 9 is a flowchart showing an example of the transmission source address selection processing 900 executed by the DNS relay unit 3120 as a part of the DNS relay processing 800. As described above, this processing is executed by using access line identification information read out from the DNS relay management table 700 as an argument.

If execution of the transmission source address selection processing 900 is started, then the DNS relay unit 3120 searches the access line management table 500 for an entry having the access line identification information extracted at Step 803 or 805 in the above-described DNS relay processing 800 registered therein. Subsequently, the DNS relay unit 3120 reads out a prefix from prefix information registered in the acquisition information field 504 of that entry. And the DNS relay unit 3120 searches IPv6 addresses set in the line I/F of the CPE router 207 connected to the PC 208 and extracts an IPv6 address having 48 high-order bits that first coincide with the prefix read out (Step 901). The DNS relay unit 3120 fixes the extracted IPv6 address as a transmission source address to be used in the DNS enquiry message (packet) generated by the CPE router 207 (Step 902). And the DNS relay unit 3120 finishes the transmission source address selection processing 900 and returns to the DNS relay processing 800 (Step 903).

Owing to the processing heretofore described, the DNS query message (packet) transmitted by the CPE router 207 has a DNS server address given as notice by some PE router, as the destination, and has a transmission source address including a prefix given as notice by that PE router. Unlike Step 407 in the above-described prefix notice processing 400, therefore, the DNS enquiry message (packet) is not discarded even if the PE router has a packet filter set therein. The notice of the prefix information from the PE router is given in order to automatically set an IPv6 address for the line I/F located between the CPE router 207 and the PC 208. It is supposed in the above-described example that it is not necessary to especially set an IPv6 global address between the PE router 205 and the PE router B 206 and the CPE router 207 and operation is conducted by setting only an IPv6 link local address. Therefore, an IPv6 global address is not set for an access line to which the CPE router 207 actually transmits a message (packet). As for an IPv6 global address required as a transmission source address of a message (packet) issued by the CPE router 207, however, it becomes possible owing to the above-described transmission source address selection processing 900 to use proper one of IPv6 addresses automatically set for the line I/Fs of the CPE router 207 connected to the PC 208. Even if an IPv6 global address is not set between the PE router A 205 and the PE router B 206 and the CPE router 207, therefore, it doesn't matter in message (packet) transmission from the CPE router 207 to each PE router.

Subsequently, operation of the PC 208 will be described concretely.

FIG. 17 is a diagram showing a hardware configuration of the PC 208.

The PC 208 includes, for example, a CPU 1710 for executing a program, a memory 1720 storing various tables and software, a hard disk 1730, a data input interface unit 1740 connected to a keyboard, a mouse, a microphone and so on to accept an input from the user, a data output interface unit 1750 connected to a display, a speaker and so on to output data, a network interface unit (line I/F) 1760 connected to the CPE router 207 via a network (line), and an internal bus 1770 connecting the components to each other.

FIG. 10 is a diagram showing a software configuration of the PC 208. The software is stored on the hard disk, read out into the memory, and executed by the CPU. The PC 208 includes a network I/F driver 1010, an IPv6 protocol processing program 1020, a TCP/UDP protocol processing program 1030, a socket processing program 1040 for conducting interface processing between an application program 1000 and the protocol processing program 1030, and an application program 1000 which makes it possible to use a use environment properly according to a plurality of IPv6 addresses.

In the present embodiment, an address generation processing program 1050 to be used in address generation and a program 1060 for selecting a transmission source address are included in the IPv6 protocol processing program 1020. Besides the above-described software programs, various tables such as a prefix management table 1100, an I/F address management table 1200 and an ISP information management table 1300 are stored in the memory 1720 in the PC 208. These tables are used by the PC 208 to generate an IPv6 address from a new prefix given as notice by the CPE router 207.

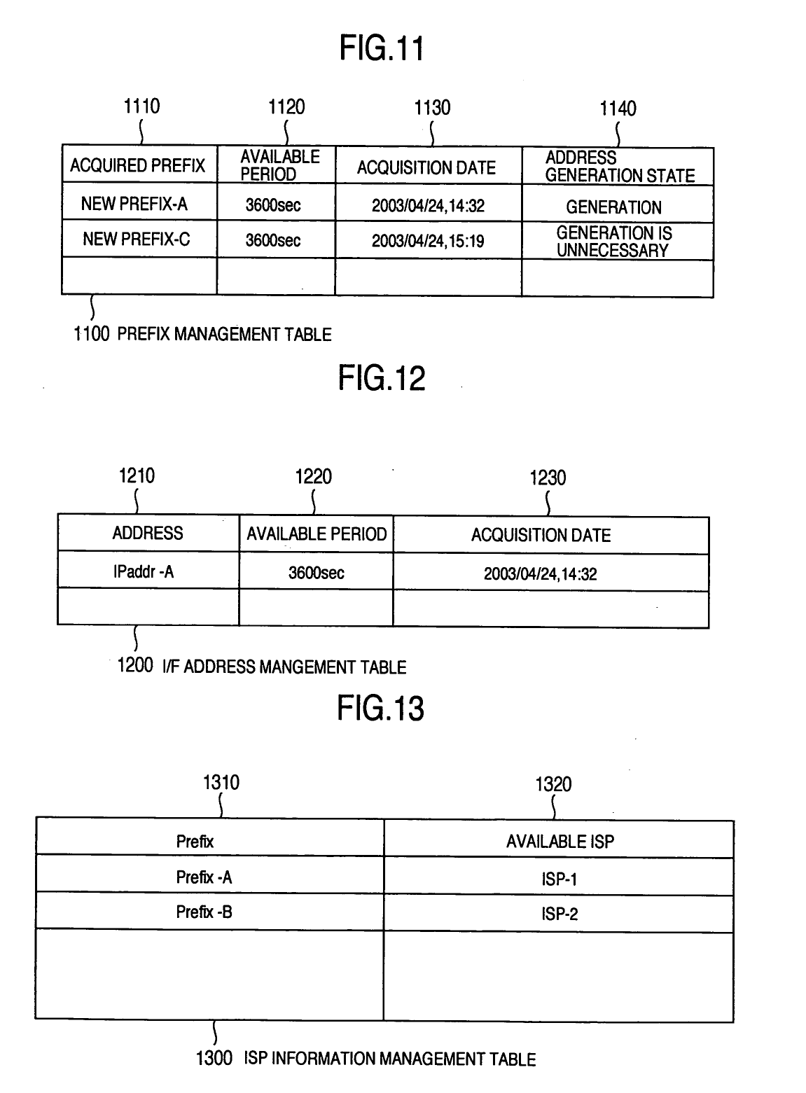

The PC 208 receives a new prefix from the CPE router 207, and generates an IPv6 address (global address). This processing will now be described with reference to FIGS. 11, 12, 13 and 14.

FIG. 11 shows a configuration example of the prefix management table 1100. The PC 208 uses the prefix management table 1100 in order to manage new prefixes given as notice by the CPE router 207. The prefix management table 1100 has an entry for each of the acquired new prefixes. Each entry includes an acquisition prefix field 1110 for registering acquired new prefix information, an available period field 1120 for registering available period information given together as notice at the time of the new prefix distribution, and an address generation state field 1140 for registering address generation state indicating information.

When an IPv6 address is generated from the registered new prefix, information that indicates “generation” as an address generation state is set in the address generation state field 1140. When address generation from the registered new prefix is not necessary, information that indicates that “generation is unnecessary” is set in the address generation state field 1140.

FIG. 12 shows a configuration example of the I/F address management table 1200. The PC 208 uses the I/F address management table 1200 in order to manage IPv6 addresses created by the PC 208 itself. The I/F address management table 1200 has an entry for each of the created addresses. Each entry includes an address field 1210 for storing an address created from the acquired new prefix, specifically storing a pair of a new prefix and an interface identifier, an available period field 1220 for registering available period information received together when the new prefix is acquired, and an acquisition date field 1230 for registering acquisition date information.

By the way, while the PC 208 is conducting communication via some access line after the CPE router 207 has given notice of a new prefix, the I/F address management table 1200 must have at least one IPv6 address registered therein.

FIG. 13 shows a configuration example of the ISP information management table 1300. The PC 208 uses the ISP information management table 1300 in order to manage available ISPs and prefixes respectively associated with the ISPs. The ISP information management table 1300 has an entry for each of the ISPs. Each entry includes a prefix field 1310 for registering a prefix distributed from the PE router of each of ISPs that can be utilized by the user using the PC 208, and an available ISP field 1320 for registering identification information of an ISP that distributes that prefix and that can be used by the user.

In the network shown in FIG. 2, the ISP1, which provides the user using the PC 208 with the Internet service, and the ISP2, which provides the user using the PC 208 with the VPN service, distribute prefixes to the CPE router 207 from the PE router A 205 and the PE router B 206. In FIG. 13, therefore, the prefixes of the two kinds are respectively associated with the ISP1 and ISP2, and previously registered in the ISP information management table 1300 by the user.

By the way, the ISP information management table 1300 is not restricted to the form in which the user registers usable ISPs as described above. For example, typical prefixes distributed from a prominent ISP group and respective ISPs may be previously registered in the user terminal by the user terminal manufacturer or manufacturers of various kinds of software such as an operating system. When attempting to connect a user terminal to the Internet, prefixes may be distributed to the user terminal by an arbitrary ISP that provides Internet service. The user terminal discriminates usable ISPs by referring to the ISP information management table 1300 thus subjected to registration.

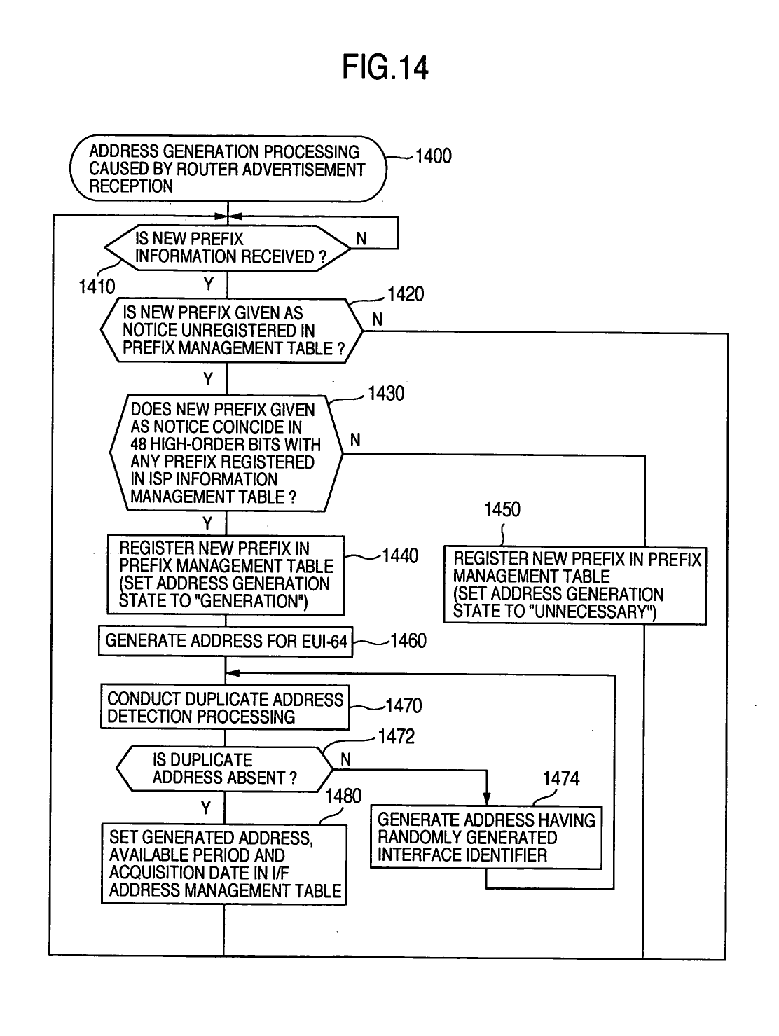

The PC 208 receives a new prefix from the CPE router 207, and generates an IPv6 address (global address). FIG. 14 is a flowchart showing an example of this processing (address generation processing) 1400.

In the address generation processing 1400, the PC 208 waits for notice of a new prefix, which is given by the CPE router 207 by means of the router advertisement (Step 1410). Upon receiving a new prefix from the CPE router 207, the PC 208 determines whether a prefix coinciding with the new prefix has already been registered in any entry in the prefix management table 1100 (Step 1420). If the coincident prefix has already been registered in the prefix management table 1100, then the new prefix has already been received, and consequently the address generation processing is finished and the processing returns to Step 1410.

If a coincident prefix registered in the prefix management table 1100 is not found, then the PC 208 determines whether a prefix coinciding in 48 high-order bits with the new prefix given as notice is already registered in any entry in the ISP management information table 1300 (Step 1430). If a coincident prefix is not found from among prefixes registered in the ISP management information table 1300, then the new prefix given as notice does not include a prefix distributed from an ISP that can be used by the user. Therefore, the PC 208 sets a new entry in the prefix management table 1100, and registers information of the new prefix given as notice, the available period and the acquisition date in corresponding fields of the new entry on the basis of the received router advertisement information. However, the PC 208 sets information indicating that address “generation is unnecessary” in the address generation state field 1140 (Step 1450).

If a coincident prefix registered in the ISP information management table 1300 is found, then the new prefix includes a prefix distributed from an ISP that can be used by the user. Therefore, the PC 208 sets a new entry in the prefix management table 1100, and registers information of the new prefix given as notice, the available period and the acquisition date in corresponding fields of the new entry on the basis of the received router advertisement information, and sets information indicating address “generation” in the address generation state field 1140 (Step 1440).

Subsequently, the PC 208 generates an EUI-64 identifier (a 64-bit global identifier prescribed by IEEE) on the basis of an MAC address of the Ethernet (registered trademark) assigned to the PC 208 itself, and uses it as an interface identifier corresponding to the new prefix given as notice. However, it is not necessary to always use an MAC address at the beginning of interface identifier generation. From the beginning, a randomly generated numerical value may also be used as the interface identifier. And the PC 208 combines the generated interface identifier with the new prefix and thereby creates an IPv6 address (global address) (Step 1460).

Thereafter, the PC 208 determines by using duplicate address detection processing that the created address is not a duplicate address. The duplicate address detection processing is processing of sending a neighbor request message to request multi-cast addresses and judging that there is no duplication of the generated address if there is no duplication notice using neighbor notice for a fixed time (Steps 1470 and 1472). If a duplication notice is received and duplication of an address is detected, then the processing of the new interface identifier generation and duplicate address detection processing are repeated until a nonduplicative address is generated. As for a method for generating a new interface identifier, there is a method of, for example, generating a three-byte random numerical value and combining three low-order bytes representing the generated value with five high-order bytes set to 0. Although a three-byte random numerical value has been generated here, the size of the generated numerical value may be an arbitrary number of bytes so long as it does not exceed eight bytes (Step 1474).

Upon ensuring that there is no duplicate address, the PC 208 adds a new entry to the I/F address management table 1200, registers the generated IPv6 address in the address field 1210 of that entry, and also registers information of an available period and acquisition data respectively in the corresponding fields. The information of the available period and acquisition data is information given as notice together with the new prefix by the CPE router 207 (Step 1480).

And the PC 208 returns to Step 1410, which is the first step of the address generation processing 1400.

Owing to the processing heretofore described, the PC 208 can receive a router advertisement from the CPE router 207, acquire a plurality of new prefixes, create a plurality of IPv6 addresses according to prefix contents contained in the new prefixes, and manage the IPv6 addresses.

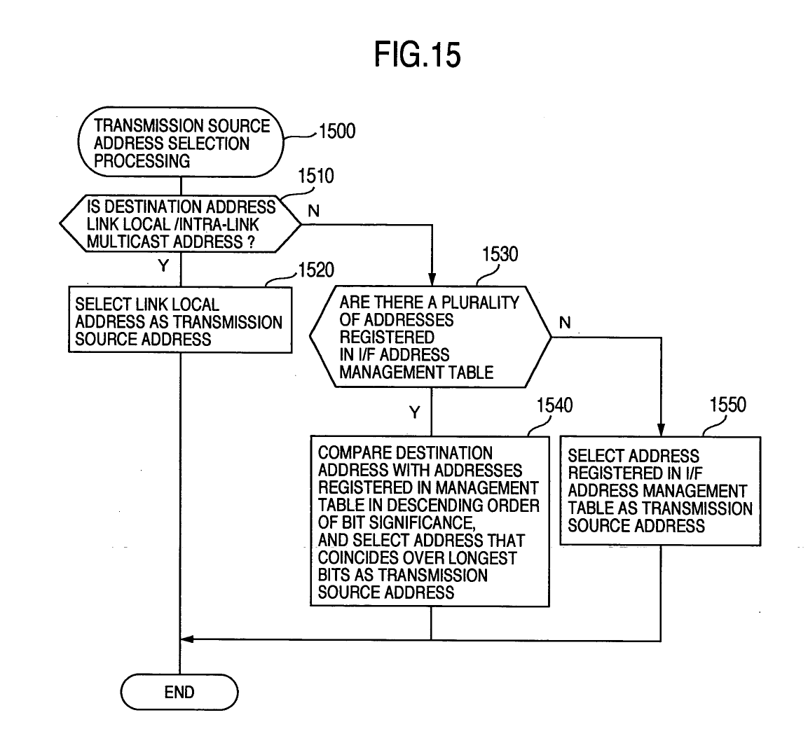

The PC 208 uses the created IPv6 addresses and utilizes service provided by some ISP. Transmission source address selection processing in this case will now be described with reference to FIG. 15.

FIG. 15 is a flowchart showing an example of transmission source address selection processing 1500 conducted by the PC 208.

This processing is premised on the following supposition. The PC 208 sends a DNS query concerning a domain name of an ISP to the CPE router 207 in order to utilize service provided by the ISP. The CPE router 207 conducts the above-described DNS relay processing 800, acquires an IP address corresponding to the subject domain name from the DNS server, and gives notice of the acquired IP address to the PC 208 as a response to the DNS query. And the PC 208 receives the DNS response from the CPE router 207, and acquires the IP address corresponding to the subject domain name. Or it is supposed that information of a destination to be communicated with (such as a management address, a link local address, or an intra-link multicast address) is previously set in the PC 208. The PC 208 may have acquired the address information of the destination by using some other method.

In the transmission source address selection processing 1500, the PC 208 determines whether the address of the destination to be communicated with, which has been acquired by one of the above-described methods, is a management address such as a link local address or an intra-link multicast address (Step 1510). If the destination address is a link local address or an intra-link multicast address, then the PC 208 selects a link local address, which is a management address already set from the CPE router 207, as a transmission sources address to be used for packet transmission (Step 1520).

On the other hand, if the destination address is neither a link local address nor an intra-link multicast address, for example, if the destination address is an IP address acquired by a DNS enquiry or the like, then the PC 208 refers to the I/F address management table 1200, and determines whether there are a plurality of IPv6 addresses registered in the I/F address management table 1200 (Step 1530). If there is only one IPv6 address registered in the I/F address management table 1200, then the PC 208 selects that IPv6 address as the transmission source address (Step 1550).

If there are a plurality of IPv6 addresses registered in the I/F address management table 1200, then the PC 208 compares the destination address with the IPv6 addresses registered in the I/F address management table 1200 in a descending order of bit significance. In other words, the PC 208 compares a value of each of bits included in the destination address with a value of the corresponding bit included in each of the IPv6 addresses in a descending order of bit significance. The PC 208 selects an IPv6 address having bit values that coincide with the bit values in the destination address over the longest bits as a result of the comparison, as the transmission source address (Step 1540).

Owing to the processing heretofore described, it becomes possible for the PC 208 to conduct communication by using a transmission source address that is the most proper for each destination.

Subsequently, another example of processing in which the PC 208 receives a new prefix from the CPE router 207 and generates an IPv6 address (global address) will be described.

FIG. 18 shows another example of the I/F address management table. Each entry in an I/F address management table 1800 includes a registration number field 1810, an address field 1820, an available period field 1830, an acquisition date field 1840, and a use environment field 1850 for registering information that indicates a use environment therein. A registration number for managing a created address is registered in the registration number field 1810. The address field 1820, the available period field 1830 and the acquisition date field 1840 are the same as the address field 1210, the available period field 1220 and the acquisition date field 1230 shown in FIG. 12.

An application identifier and a user identifier are set in the use environment field 1850. The application identifier identifies an application that uses a plurality of IPv6 addresses properly. The user identifier identifies a use environment of the application. These are associated with an IPv6 address stored in the same entry. Here, the use environment is information specifying who is using what application in the PC 208. Specifically, the use environment includes an application executed in the PC 208, a user who uses that application and identification information of the user. By the way, the information indicating the use environment may be, for example, only one of the user identification and the application identifying information.

FIG. 19 shows an example of an address generation management table 1900. The PC 208 manages the information of the use environment in which an IPv6 address should be generated, by using the address generation management table 1900. The address generation management table 1900 includes a plurality of entries. Each entry includes an application identifier field 1910, a user identifier field 1920 and a registration number field 1930. An application identifier is registered in the application identifier field 1910. A user identifier is registered in the user identifier field 1920. The registration number registered in the I/F address management table 1800 is registered in the registration number field 1930.

The PC 208 generates a plurality of addresses on the basis of the information of the new prefix received from the CPE router 207 and the information registered in the address generation management table 1900. For example, in the initialization processing conducted when executing application software of a VOIP client, the PC 208 registers an application identifier corresponding to that application software in the application identifier field 1910 in the address generation management table 1900. Furthermore, the PC 208 registers a user identifier determined as client information of the VOIP service every service contract, in the user identifier field 1920 in the address generation management table 1900.

When generating an IPv6 address, therefore, the PC 208 selects a combination of an application identifier and a user identifier from the address generation management table 1900 according to a kind of the service contract, such as a personal contract or a corporation contract. And it becomes possible for the PC 208 to generate a plurality of IPv6 addresses differing from service contract to service contract.

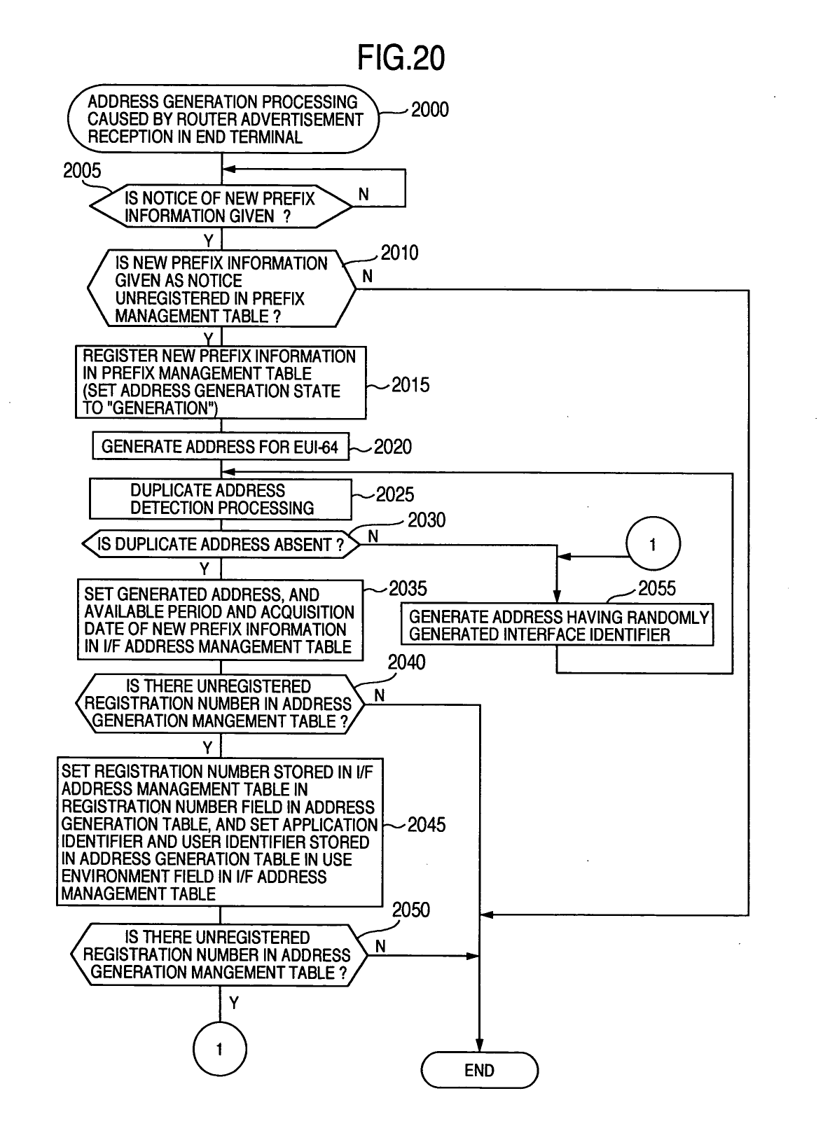

FIG. 20 is a flowchart showing another example of address generation processing conducted by the PC 208.

Upon starting address generation processing 2000, the PC 208 waits for reception of a router advertisement (Step 2005). Upon receiving a router advertisement, the PC 208 determines whether a new prefix given as notice is already registered in the prefix management table 1100. If it is already registered, then the PC 208 finishes the processing (Step 2010).

If the new prefix given as notice is not yet registered in the prefix management table 1100, then the PC 208 creates a new entry, and sets information of the new prefix, available period and acquisition date given as notice in the fields 1110, 1120 and 1130 of the created entry. In addition, the PC 208 sets the information representing “generation” in the field 1140 of the new entry (Step 2015).

Subsequently, the PC 208 generates an EUI-64 identifier (a 64-bit global identifier prescribed by the IEEE) on the basis of a MAC address of Ethernet (registered trademark) assigned to itself, and uses it as an interface identifier corresponding to the new prefix given as notice. The PC 208 creates an IPv6 address by combining the generated interface identifier with the new prefix (Step 2020). However, it is not necessary to always use a MAC address at the beginning of the interface identifier generation, but a randomly generated numerical value may be used for the interface identifier from the beginning.

The PC 208 determines whether the created address is a duplicate address by using the duplicate address detection processing (Steps 2025 and 2030).

Upon receiving a duplicate notice and detecting that the address is duplicate, the PC 208 repeats the new interface identifier generation and the duplicate address detection processing until a nonduplicating address is generated (Steps 2055, 2025 and 2030).

Upon ensuring that there is no address duplication, the PC 208 adds a new entry to the I/F address management table 1800, registers the generated address in the address field 1820 of that entry, and sets a registration number indicating the order in which registration has been conducted, in the registration number field 1810. In addition, the PC 208 sets the information of the available period and acquisition date of the new prefix in the fields 1830 and 1840, respectively (Step 2035).

Subsequently, the PC 208 refers to the address generation management table 1900. If there are no entries registered in the address generation management table 1900, then the PC 208 finishes the processing (Step 2040).

If there is only one entry in the address generation management table 1900, then the PC 208 sets the registration number that has been set in the registration number field 1810 in the I/F address management table 1800 at Step 2035, in the registration number field 1930. In addition, the PC 208 sets the application identifier and the user identifier stored respectively in the fields 1910 and 1920 of one entry in the address generation management table 1900, in the use environment 1850 of the corresponding entry in the I/F address management table 1800 (Step 2045).

If there are two or more entries registered in the address generation management table 1900 (Step 2050), then the PC 208 returns to Step 2055, generates an interface identifier again, creates a new address, and sets the new address in the I/F address management table 1800.

Owing to the processing described above, the PC 208 can create a corresponding IPv6 address for each of combinations of the application identifier and the user identifier. Specifically, the PC 208 manages combinations of the application executed in the PC 208 and the user using the application (combinations of the application identifier and the user identifier) on the basis of the address generation management table 1900. When generating an IPv6 address from a new prefix, the PC 208 generates as many addresses as the managed combinations. As a result, the PC 208 can prepare as many IPv6 addresses as the use environments of the applications at the time of address generation.

By the way, as the method for generating an address corresponding to the use environment of the application, the PC 208 may previously prepare an IPv6 interface identifier for each service use environment permitted when contracting with a service provider who provides application service. In this case, a field for managing previously prepared interface identifiers is provided in the address generation management table 1900 in the PC 208. Instead of generating an interface identifier randomly, the PC 208 generates an IPv6 address by using the previously prepared interface identifier, at Step 2055 shown in FIG. 20.

In the description of FIG. 20, the PC 208 generated a plurality of IPv6 addresses when notice of a new prefix is given to the PC 208. Alternatively, the PC 208 may generate an IPv6 address when an application is started in the PC 208, and the PC 208 may erase that IPv6 address when the application is finished.

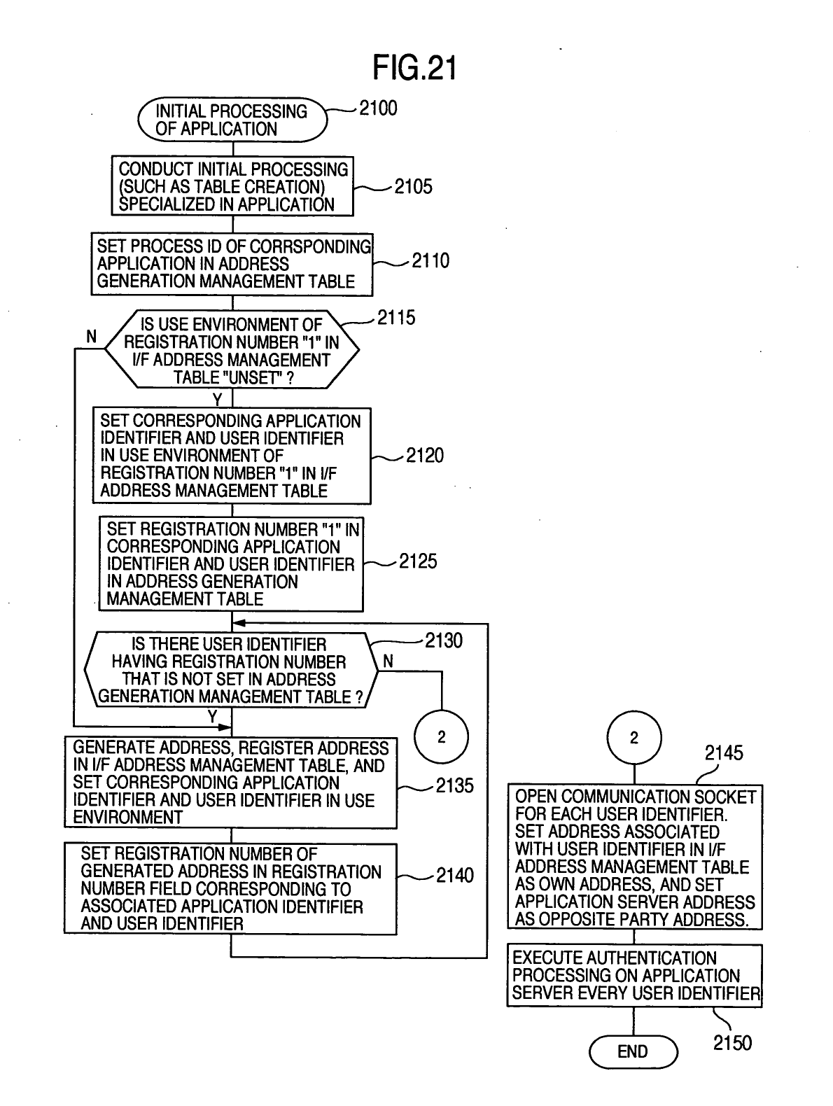

Hereafter, a procedure of processing of generating an address in the PC 208 when an application is started will be described with reference to FIGS. 21 and 28.

By the way, upon receiving notice of a new prefix previously, the PC 208 executes Steps 2005 to 2035 in the flowchart shown in FIG. 20, and registers the generated address and so on in the I/F address management table.

FIG. 28 shows another example of the address generation management table. In the same way as each entry in the address generation management table 1900, each entry in an address generation management table 2800 shown in FIG. 28 has an application identifier field 2810, a user identifier field 2820 and a registration number field 2830. In addition, each entry in the address generation management table 2800 has a process ID field 2840. A process identifier (process ID) given by the OS in the PC 208 at the time of application program start is registered in the process ID field 2840. As described with reference to FIG. 19, the application identifier and the user identifier are previously registered in the address generation management table 2800. On the other hand, it is supposed that nothing is registered in the registration number field 2830.

FIG. 21 is a flowchart showing a procedure of initial processing 2100 conducted when application software is started in the PC 208.

Upon starting an application, the PC 208 conducts initial processing such as table creation specialized in the application (Step 2105).

Subsequently, the PC 208 extracts at least one entry in which an application identifier of the started application is registered, from the address generation management table 2800. The PC 208 sets a process ID of the started application in the process ID field 2840 in each of the extracted entries (Step 2110).

Subsequently, the PC 208 determines whether contents of the use environment field 1850 in the I/F address management table 1800 for an entry having a value in the registration number field 1810 equivalent to “1” are “null” (contents are not yet set) (Step 2115). If the field 1850 indicates “null,” then the PC 208 selects one from among the one or more entries in the address generation management table 2800 extracted at Step 2110. The PC 208 reads out an application identifier and a user identifier respectively registered in the application identifier field 2810 and the user identifier field 2820 of the selected entry. The PC 208 sets the application identifier and the user identifier thus read out in the use environment field 1850 in the I/F address management table 1800 for an entry having a value in the registration number field 1810 equivalent to “1” (Step 2120).

Thereafter, the PC 208 sets “1” in the registration number field 2830 of the entry selected at Step 2120, in the address generation management table 2800 (Step 2125).

If it is found at Step 2115 that information is already set in the use environment field 1850, then it is necessary to generate a new address. Therefore, the PC 208 conducts the same processing as Steps 2055, 2025 to 2035 in the flowchart shown in FIG. 20, and generates an address by using a new prefix registered in the prefix management table 1100. The PC 208 adds a new entry to the I/F address management table 1800, registers the generated address in the address field of the entry, and sets information in the fields 1810, 1830 and 1840. In addition, the PC 208 executes processing similar to that of Step 2120, and sets an application identifier and a user identifier in the use environment field 1850 of the added entry (Step 2135). Furthermore, the PC 208 executes processing similar to that of Step 2125, and sets a registration number set in the added entry in the registration number field 2830 of the entry selected at Step 2135 (Step 2140).

Subsequently, the PC 208 checks the one or more entries extracted from the address generation management table 2800 at Step 2110, and determines whether there is an entry having a registration number that is not registered in the registration number field 2830 (Step 2130). Also in the case where there are one or more unregistered entries at Step 2130, new address generation for each entry becomes necessary. In this case as well, the PC 208 executes Step 2135. In other words, the PC 208 generates a new address, adds a new entry to the I/F address management table 1800, registers the newly generated address and so on in the entry, and sets an application identifier and a user identifier in the use environment field 1850 of the entry (Step 2135). In addition, the PC 208 executes Step 2140 to set a registration number in the registration number field 2830 of the entry selected at Step 2135, in the address generation management table 2800.

The PC 208 repeats Steps 2130 to 2140 until an entry having a registration number that is not registered in the registration number field 2830 disappears.

If the one or more entries extracted from the address generation management table 2800 are judged at Step 2130 not to include an entry having a registration number that is not registered in the registration number field 2830, then the PC 208 proceeds to processing of Step 2145. At Step 2145, the PC 208 extracts one or more entries having an application identifier of a started application registered in the use environment field 1850, from the I/F address management table. The PC 208 opens a communication socket for each of user identifiers registered in the use environment field 1850 of each of the extracted entries. As a transmission source address (own address) to be used in order to conduct communication by using respective communication sockets, the PC 208 reads out an address associated with each user identifier from the I/F address management table 1800, and sets the address. Furthermore, the PC 208 sets an address of an application server as a destination address (opposite party address) to be used to conduct communication by using each communication socket (Step 2145). Thereafter, the PC 208 executes authentication processing on the application server every communication socket (Step 2150), and starts communication (utilization of application service) using the started application.

Owing to the processing heretofore described, the PC 208 can generate and use as many IPv6 addresses as needed in accordance with the start of the application.

When terminating the application that has been executed, the PC 208 releases addresses associated with use environments of the application.

The PC 208 conducts termination processing specialized in the application that has been executed (Step 2205). In the termination processing, for example, table information saving is conducted. Subsequently, the PC 208 extracts one or more entries having the process ID of the application to be terminated set therein, from the address generation management table 2800. The PC 208 refers to a registration number registered in each of extracted entries. The PC 208 extracts one or more entries having the same registration number as each of registration numbers referred to, therein from the I/F address management table 1800, and sets information indicating “release phase” in the use environment field 1850 of each of extracted entries (Step 2210). Furthermore, the PC 208 sets a value indicating “null” in the registration number field 2830 of one or more entries extracted from the address generation management table 2800 (Step 2215).

Subsequently, the PC 208 starts an address release timer, which is not illustrated (Step 2220), and waits for timeout of the address release timer (Step 2225). Upon timeout of the address release timer, the PC 208 refers to the registration number field 1810 of each entry in the I/F address management table 1800. If there is an entry having a value of “1” in the registration number field 1810 (Step 2230), then the PC 208 sets “null” in the use environment field 1850 of that entry (Step 2235). If there is an entry having a value other than “1” in the registration number field 1810, then the PC 208 deletes all entries having a value other than “1” in the registration number field 1810, from the I/F address management table 1800 (Step 2240).

At the time of application termination, the PC 208 releases addresses associated with the application to be terminated, from the address generation management table 2800 as described above. By means of this processing, the PC 208 erases setting of IPv6 addresses that have become unnecessary, and the PC 208 does not have extra IPv6 addresses.

In the description of FIG. 20, use of the ISP information management table 1300 shown in FIG. 13 has not been especially mentioned. After Step 2010, however, the PC 208 may determine whether a prefix that coincides in 48 high-order bits with a new prefix given as notice is already registered in the ISP information management table as described with reference to FIG. 14.

Furthermore, in Step 2135 in FIG. 21 as well, the PC 208 can generate an address by using a new prefix containing a prefix registered in the ISP information management table.

Even if the CPE router 207 gives notice of a plurality of new prefixes to the PC 208, therefore, the PC 208 can generate a plurality of addresses by using some new prefix every application.

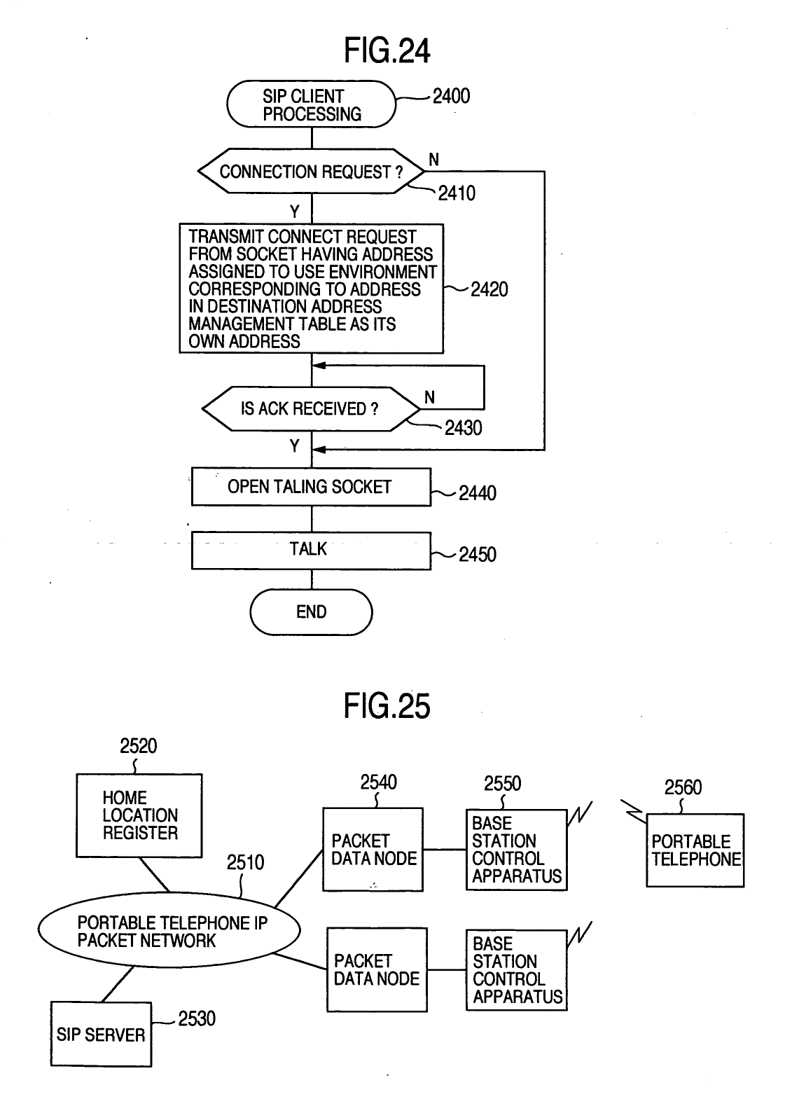

A procedure of processing conducted by the PC 208 when executing an application program that uses use environments properly will now be described with reference to FIGS. 23 and 24. In an example shown in FIGS. 23 and 24, the application program is a VoIP (Voice Over IP) client (SIP (Session Initiation Protocol) client).

FIG. 23 shows a configuration example of a destination address management table 2300 for managing basic information of an address notebook provided for the user by the SIP client. The destination address management table 2300 is stored in, for example, the memory 1720 shown in FIG. 17. The destination address management table 2300 has a plurality of entries. Each entry includes a name field 2310, a destination user address field 2320 and a user identifier field 2330. A name of the opposite party of talking is registered in the name field 2310. An address of the opposite party of talking is registered in the destination user address field 2320. A user identifier of a user who utilizes the SIP client is registered in the user identifier field 2330. When the user registers the address of the opposite party of talking, the user identifier is also registered in addition to the name and the address. In the case where the user uses, for example, an address for a corporation (address to be used by the user serving as an office worker) and an address for an individual (address for private use) properly, a different user identifier is assigned to the user every address. In the destination address management table 2300 as well, therefore, an entry is generated every user identifier.

FIG. 24 is a flowchart showing processing of call setting conducted by the SIP client.

Upon accepting a connection request from the user (Step 2410), the SIP client extracts entries having destination information (name or destination user address) specified by the user set therein, from the destination address management table 2300. The SIP client reads out a user identifier registered in the user identifier field 2330 of the extracted entry. The SIP client extracts an entry having the user identifier read out and an application identifier of the SIP client registered therein, from the address generation management table 1900 (or 2800), and reads out a registration number from the registration number field 1930 or 2830 of that entry. The SIP client extracts an entry in which the same registration number as the registration number thus read out is set, from the I/F address management table 1800, and reads out an address from the address field 1820 of the extracted entry.

The SIP client transmits a connect request to an application server (here, an SIP server) via a communication socket having the obtained address set as the transmission source address (own address) (Step 2420).

The SIP client waits for a response (“Ack”) from the application server (SIP server) (Step 2430). Upon receiving the “Ack,” the SIP client opens a talking socket, in which an IPv6 address of the opposite party of talking given as notice by the “Ack” is set as a destination address and the address obtained at Step 2420 is set as a transmission source address (Step 2440). The SIP client starts talking via the talking socket (Step 2450).

In this way, the SIP client manages the destination information of the opposite party of talking and the user identifier so as to associate them with each other. As a result, it becomes possible for the SIP client to discriminate a user identifier on the basis of destination information selected by the user and select an address to be used at the time of talking.

By the way, in the example heretofore described, one application program utilizes a plurality of addresses. However, there may be a plurality of such application programs. In this case, the PC 208 may generate as many addresses as the use environments of the applications. Or different use environments of different applications may share one address. In this case, the PC 208 registers a plurality of use environments (combinations of the application identifier and the user identifier) in the use environment field 1850 in the I/F address management table 1800. When terminating an application program, the PC 208 deletes use environments concerning that application program from the use environment field 1850.

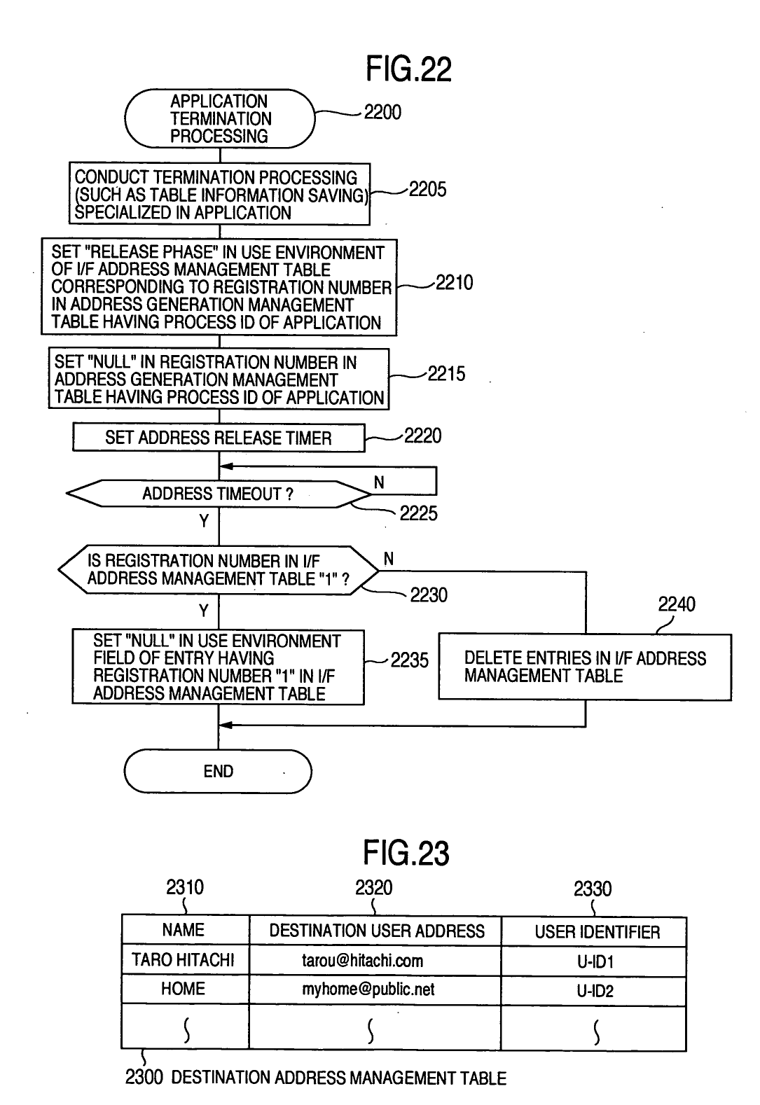

In addition, if all use environments have been deleted from the use environment field 1850 of each entry in the I/F address management table 1800, then the PC 208 executes Steps 2220 to 2240 shown in FIG. 22.

In the PC 208, therefore, a plurality of applications can share one address.

An example in which a user terminal conducts talking using the SIP via an IP packet network will now be described with reference to FIGS. 25, 26 and 27. In this example, the IP packet network is an IP packet network for portable telephone, and the user terminal is a portable telephone.

FIG. 25 shows a configuration of an IP packet network system for portable telephone.

In FIG. 25, a home location register 2520, a SIP server 2530, and packet data nodes 2540 are connected to an IP packet network 2510 for portable telephone. A base station control apparatus 2550 is connected to each of the packet data nodes 2540. The base station control apparatus 2550 includes a wireless base station, and conducts wireless data transmission and reception with a portable telephone 2560.

The portable telephone 2560 is connected to the packet data node 2540 via the base station control apparatus 2550. The home location register 2520 manages authentication information and location information of the portable telephone 2560. The SIP server 2530 is an application server that provides the portable telephone 2560 with telephone service using the SIP. The portable telephone 2560 issues a talking service request to the SIP server 2530 via the packet data node 2540.

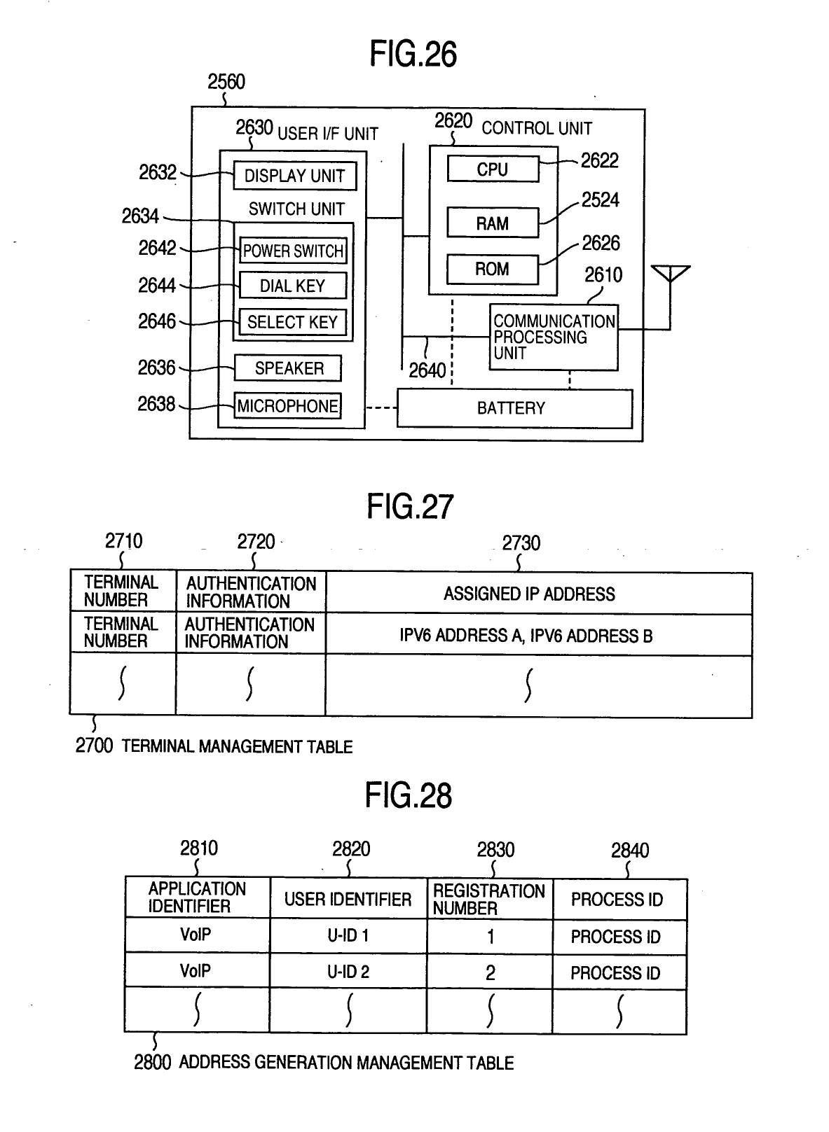

FIG. 26 shows an example of a hardware configuration of the portable telephone 2560.

The portable telephone 2560 includes a communication processing unit 2610, a control unit 2620, a user I/F unit 2630, and an internal bus 2640 for connecting them with each other. The communication processing unit 2610 controls wireless communication. The control unit 2620 includes a CPU 2622, a RAM 2624, and a ROM 2626, and conducts control on the user I/F unit, and conducts application processing and protocol processing of the IP layer and a higher layer. The user I/F unit 2630 includes a display unit 2632, a switch unit 2634, a speaker 2636, and a microphone 2638. The switch unit 2634 includes a power switch 2642, a dial key 2644, and a select key 2646. The user of the portable telephone 2560 can select a use environment by operating the select key 2646.

The select key 2646 has two states: “on” and “off.” The user can set the use environment in the “on” or “off” state by using the select key 2646. Before starting utilization of telephone service, the portable telephone 2560 conducts generation of the address generation management table 2800 and association of the select key 2646 and the use environment according to a procedure hereafter described, by using an application initialization program executed in the control unit 2620.

In response to first start operation of an application conducted by the user, the portable telephone 2560 displays an input view of a user identifier determined for each utilization contract of telephone service, on the display unit. If the user inputs a user identifier, then the portable telephone 2560 sets an application identifier and a user identifier (use environment) in the application identifier field 2810 and the user identifier field 2820 of one entry in the address generation management table 2800.

Subsequently, the portable telephone 2560 displays a user address corresponding to one user identifier and the select key state on the display unit, and makes the user select one of the two states “on” and “off.” If there is another user identifier, then the portable telephone 2560 displays a user address corresponding to that user identifier and the select key state in the same way, and makes the user select one of the states. As a result, the portable telephone 2560 manages the states of the select key and the user identifiers so as to associate them with each other.

In FIG. 26, the portable telephone 2560 has only one select key 2646. Therefore, the user can select only two use environments. Alternatively, the user may conduct selection from among three or more use environments by providing the portable telephone 2560 with a plurality of select keys 2646 or using a combination of the select key 2646 and the dial key 2644.

In FIG. 25, the packet data node 2540 conducts processing similar to the processing conducted by the CPE router 207. Upon receiving notice of a new prefix from the packet data node 2540, the portable telephone 2560 can generate a plurality of addresses according to the use environment.

In addition, programs corresponding to the address generation processing shown in FIG. 14 or 20, the application initial processing shown in FIG. 21, the application termination processing shown in FIG. 22, and the SIP client processing shown in FIG. 24 are stored in the ROM 2626 in the portable telephone 2560, and the respective programs are executed by the CPU 2622. Furthermore, the prefix management table 1100, the I/F address management table 1800 and the address generation management table 2800 are stored in the RAM 2624 in the portable telephone 2560.

In the application initial processing, the portable telephone 2560 sets values in the registration number field 2830 and the process ID field 2840 of all entries in the address generation management table 2800.

When the user starts talking, the user selects a use environment by operating the select key 2646. If the select key 2646 is operated, then a state signal is output from the switch unit 2634. This state signal arrives at the control unit 2620 via the internal bus 2640. Upon accepting this state signal, the control unit 2620 conducts use environment selection processing according to a procedure hereafter described.

First, the control unit 2620 ascertains the state of the select key 2646 on the basis of the accepted state signal, and recognizes the user identifier associated with that state.

Subsequently, the control unit 2620 extracts an entry having the recognized user identifier registered therein, from the address generation management table 2800, and reads out a process ID set in the process ID field 2840 of that entry. The control unit 2620 starts the call setting processing conducted by the SIP client shown in FIG. 24, as an application program provided with the process ID read out.

Although the control unit 2620 accepts destination information specified by the user, the control unit 2620 already recognizes the user identifier. Furthermore, the control unit 2620 also already recognizes an entry having that user identifier registered therein, in the address generation management table. At Step 2420 shown in FIG. 24, therefore, the control unit 2620 reads out a registration number from the registration number field of the extracted entry in the address generation management table, and extracts an entry having the same registration number as the registration number read out set therein, from the I/F address management table 1800. The control unit 2620 acquires an address from the address field 1820 of the extracted entry, and transmits a connect request to the SIP server 2530 via the communication socket having the obtained address set as the transmission source address (own address). Thereafter, Steps 2430 to 2450 shown in FIG. 24 are executed by the control unit 2620. As a result, talking using the portable telephone 2560 becomes possible.

When power is turned on in the portable telephone 2560 and the portable telephone 2560 is connected logically to the IP packet network 2510, it is also possible for the portable telephone 2560 to acquire as many IPv6 addresses as required from the home location register 2520 as a part of authentication processing executed on the home location register 2520 connected to the IP packet network 2510 by the portable telephone 2560.

FIG. 27 shows a configuration example of a terminal management table 2700 included in the home location register 2520. The terminal management table 2700 has a plurality of entries. Each entry includes a terminal number field 2710, an authentication information field 2720, and an IP address field 2730. A number previously assigned to a portable telephone (terminal) managed by the home location register 2520 is registered in the terminal number field 2710. Information required to authenticate each portable telephone is registered in the authentication information field 2720. One or more IPv6 addresses to be assigned to portable telephones that could be authenticated are registered in the IP address field 2730.

By thus previously registering terminal numbers and authentication information and one or more IPv6 addresses in the terminal management table 2700 so as to associate them with each other, the home location register 2520 can distribute a plurality of IPv6 addresses prepared for a portable telephone at the time of authentication of the portable telephone.

As heretofore described, the portable telephone 2560 executes various kinds of processing. As a result, it becomes possible for the user to conduct talking using the SIP by using the portable telephone 2560.

In the present invention, in one end terminal, a plurality of IPv6 addresses are generated on the basis of one or more pieces of distributed prefix information, and communication is conducted by using a socket having its own address differing according to the use environment assigned thereto, as heretofore described. As a result, it becomes possible to use different user's use environments of one application properly according to the IPv6 address.

It should be further understood by those skilled in the art that although the foregoing description has been made on embodiments of the invention, the invention is not limited thereto and various changes and modifications may be made without departing from the spirit of the invention and the scope of the appended claims.

1. A network system comprising:
one or more first internetwork apparatuses connected to a network; and
a second internetwork apparatus connected to the one or more first internetwork apparatuses respectively via access lines and connected to a user apparatus,
wherein each of said first internetwork apparatuses comprises:
a storage unit for retaining a plurality of IPv6 address prefixes; and
a server unit for giving notice of an arbitrary IPv6 address prefix included in the retained IPv6 address prefixes to said second internetwork apparatus in response to a request from said second internetwork apparatus,
wherein said second internetwork apparatus comprises:
a prefix request unit for requesting an IPv6 address prefix from each of said one or more first internetwork apparatuses;
a prefix generation unit for generating a second prefix required to create an IPv6 address in the user apparatus, on the basis of each of the one or more arbitrary IPv6 address prefixes given as notice by said one or more first internetwork apparatuses; and
a prefix sending unit for giving notice of one or more generated second prefixes to the connected user apparatus.

2. The network system according to claim 1, wherein each of said one or more first internetwork apparatuses further comprises a packet filter unit for relaying only a packet having, as a transmission source address, an IPv6 address that contains the IPv6 address prefix given as notice to said second internetwork apparatus.

3. The network system according to claim 1, wherein:
said server unit in each of said first internetwork apparatuses gives notice of additional information, besides the arbitrary IPv6 address prefix, to said second internetwork apparatus, and
the additional information includes a domain name owned by a corporation that provides service via one of said first internetwork apparatuses, and includes address information of a DNS apparatus which manages address information with respect to the domain name.

4. The network system according to claim 1, wherein said prefix request unit in said second internetwork apparatus manages a line state every access line, and sends a request for the IPv6 address prefix to an access line expressed as usable by the line state.

5. The network system according to claim 3,
wherein said second internetwork apparatus further comprises:
a second storage unit for storing the additional information given as notice respectively by said first internetwork apparatuses; and
a DNS relay unit, and
wherein said DNS relay unit receives a DNS query from the user apparatus, determines whether a domain name of a subject of the received DNS query is included in the stored additional information, reads out address information of the DNS apparatus, which manages address information for the domain name, when the domain name of the subject of the received DNS query is included in the stored additional information, and transmits the received DNS query by using the address information read out as a destination address.

6. The network system according to claim 5, wherein said DNS relay unit recognizes an IPv6 address prefix given as notice together with the additional information including the domain name of the query subject, extracts an IPv6 address including an IPv6 address prefix that coincides with the recognized IPv6 address prefix, from among IPv6 addresses set on line interfaces where said second internetwork apparatus is connected to the user apparatus, and transmits the received DNS query by using the extracted IPv6 address as a transmission source address.

7. An internetwork apparatus comprising one or more routing units each having a plurality of ports respectively connected to a plurality of networks, said internetwork apparatus relaying a packet received from each network via each port to another port in accordance with a destination address contained in the packet, said internetwork apparatus comprising:
a storage unit for retaining a plurality of IPv6 address prefixes; and
a server unit responsive to a distribution request received from a different internetwork apparatus via some port, for selecting an arbitrary IPv6 address prefix from among the retained IPv6 address prefixes, and distributing the selected arbitrary IPv6 address prefix to the different internetwork apparatus.

8. The internetwork apparatus according to claim 7, further comprising a packet filter unit for relaying only a packet having, as a transmission source address, an IPv6 address that contains the arbitrary IPv6 address prefix distributed to the different internetwork apparatus.

9. The internetwork apparatus according to claim 7, wherein
said server unit gives notice of additional information, besides the arbitrary IPv6 address prefix, to the different internetwork apparatus, and
the additional information includes a domain name owned by a corporation that provides service via said internetwork apparatus, and address information of a DNS apparatus which manages address information with respect to the domain name.

10. An internetwork apparatus including one or more relay units each having a plurality of ports connected to a plurality of networks, said internetwork apparatus being connected to one or more different internetwork apparatuses and a user apparatus via a network connected to some port, and said internetwork apparatus relaying a packet received via each port to another port in accordance with a destination address contained in the packet, said internetwork apparatus comprising:
a prefix acquisition unit,
wherein said prefix acquisition unit comprises:
a prefix request unit for requesting each of the one or more different internetwork apparatuses to distribute an IPv6 address prefix;
a prefix generation unit for generating a second prefix required to create an IPv6 address in the user apparatus, on the basis of each of the one or more arbitrary IPv6 address prefixes given as notice by the one or more different internetwork apparatuses; and
a prefix sending unit for giving notice of generated second prefixes to the user apparatus.

11. The internetwork apparatus according to claim 10, further comprising a storage unit for storing state indicating information as regards each of one or more networks connected to the one or more different internetwork apparatuses,
wherein said prefix request unit requests the one or more different internetwork apparatuses connected via networks expressed as usable by state indicating information stored in said storage unit, to distribute the IPv6 address prefix.

12. The internetwork apparatus according to claim 10, wherein said storage unit stores information given as notice together with the arbitrary IPv6 address prefix by the one or more different internetwork apparatuses, the information including a domain name owned by a corporation that provides service via the one or more internetwork apparatuses, and address information of a DNS apparatus which manages address information with respect to the domain name.

13. The internetwork apparatus according to claim 12, further comprising a DNS relay unit,
wherein said DNS relay unit receives a DNS query from the user apparatus, determines whether a domain name of a subject of the received DNS query is included in the information stored in said storage unit, extracts address information of the DNS apparatus which manages address information for the domain name when the domain name of the query subject is included in the stored additional information, and transmits the received DNS query by using the extracted address information as a destination address.

14. The internetwork apparatus according to claim 13, wherein said DNS relay unit recognizes the arbitrary IPv6 address prefix given as notice together with the information including the domain name of the query subject, extracts an IPv6 address including an IPv6 address prefix that coincides with the recognized arbitrary IPv6 address prefix, from among IPv6 addresses set on ports where said internetwork apparatus itself is connected to the user apparatus, and transmits the received DNS query by using the extracted IPv6 address as a transmission source address.
